(19) United States
(12) Patent Application Publication
(10) Pub. No.: US 2025/0342282 A1
(43) Pub. Date: Nov. 6, 2025

(54) PUBLIC VERIFICATION OF SINGLE CONSISTENT HISTORY OF PRIVATE LEDGERS

(71) Applicant: TRAENT S.R.L., Milano (IT)

(72) Inventors: Claudio Felicioli, Via Giuseppe Cesare Abba 4, PISA (IT); Andrea Canciani, Via delle Medaglie d'oro 13, PISA (IT); Fabio Severino, Piazza Cairoli 3, PISA (IT)

(73) Assignee: TRAENT S.R.L., Milano (IT)

(21) Appl. No.: 18/869,556

(22) PCT Filed: May 29, 2023
(86) PCT No.: PCT/EP2023/064322

§ 371 Date: Nov. 26, 2024

(30) Foreign Application Priority Data
May 30, 2022 (IT) 102022000011387

(51) Int. Cl. G06F 21/64; G06F 21/33

(52) U.S. Cl. CPC G06F 21/645; G06F 21/33

(57) ABSTRACT

A solution is proposed for certifying data stored in one or more ledgers (105) produced in a private environment (110). A corresponding method (600) comprises calculating corresponding ledger digests (LDⱼᵢ) based on a sequence of ledger versions (LVⱼᵢ) of each ledger (105) and then calculating (605-606) corresponding consistency proofs (VCP_{ji/i-1}). Verification information based thereon for verifying that each selected ledger (105) to be verified has a single consistent history is exposed (608-614,631-634) outside the private environment, with at least part thereof that is stored (609,613) into a persistent storage (115). Moreover, a software programs (500) and a corresponding software program product are proposed. A certification computing system (410) is also proposed.

### TECHNICAL FIELD

The present disclosure relates to the information technology field. More specifically, this disclosure relates to certification of data.

### BACKGROUND

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Storing of data is a commonplace activity in most computing systems (for example, for their preservation, outputting, further processing and so on). In several situations, the storing of data is subject to specific requirements.

Particularly, it may be required that the storing of data is persistent; this means that it should not be possible to alter the data once they have been stored. Therefore, any updates of the data should preserve all previous versions of the same data; this requirement may be fulfilled in a general way by only allowing the data to be appended in sequence by producers thereof. Moreover, it may be required that access to the data is controlled. This means that access to the data should be restricted selectively to specific subjects only. All of the above allows avoiding disclosure of the data to unauthorized subjects that are not entitled to know them.

Whenever the data is provided to consumers thereof different from their producers, it is important to prove that the storing of the data is actually persistent.

For this purpose, a central entity that is generally trusted by all the involved subjects may be delegated to store the data. The central entity guarantees that the data are persistent (and that they may be accessed only by the authorized subjects). However, this requires uploading all the data to be stored to a (central) server of the central entity. The uploading of the data may involve an overloading of a network being used to communicate with the central server (especially in case of uploading of large amount of data). All of the above may involve a corresponding performance degradation. In any case, the uploading of the data to the central server may be unfeasible (such as when the data are subject to strict confidentiality requirements).

Alternatively, the data may be stored into a blockchain. In general terms, a blockchain is a distributed ledger that stores data into a sequence of blocks in chronological order, linked to each other via corresponding hash values. The blockchain is distributed throughout peer nodes of a corresponding network, which validate its content according to a consensus schema that determines the valid version of the blockchain (with no centralized version of the blockchain that exists and no node that is more trusted than any other node is).

A public (or permissionless) blockchain has no restriction on its access. In this case, the most widely used consensus schema is based on a proof of work, wherein a complex mathematical problem has to be solved by determining a nonce to be added to each block that provides a specific property of its hash value. This makes the public blockchain tamper-proof, since no block may be altered after it has been appended to the blockchain. In fact, any alteration of a block requires re-determining the nonces of this block and of all the next blocks in the blockchain; however, the difficulty of the corresponding mathematical problem makes it substantially impossible (unless a majority of the processing power of the whole network is acquired). However, the public blockchain requires a relatively large network to ensure an acceptable degree of reliability. Moreover, the solutions of the mathematical problem for appending new blocks involve a high consumption of computational resources and then of energy. A private (or permissioned) blockchain, instead, may not be joined unless invited by an owner thereof. Therefore, a far simpler consensus schema may be used (such as based on selective endorsement). However, persistency of the data may not be verified in case they are provided outside the corresponding network. Moreover, any new subject allowed to participate to a pre-existing private blockchain may verify the persistency of the data thereof only starting from its joining the corresponding network.

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In general terms, the present disclosure is based on the idea of exposing verification information at least in part stored into a persistent storage.

Particularly, an aspect provides a method for certifying data stored in one or more ledgers produced in a private environment. The method comprises calculating corresponding ledger digests based on a sequence of ledger versions of each ledger and then calculating corresponding consistency proofs. Verification information based thereon for verifying that each selected ledger to be verified has a single consistent history is exposed outside the private environment, with at least part thereof that is stored into a persistent storage.

A further aspect provides a software program for implementing the method.

A further aspect provides a corresponding software program product.

A further aspect provides a certification computing system for performing the method.

A further aspect provides an information technology infrastructure comprising the certification computing system.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes, like value, content and representation). Particularly:

FIG. 1A-FIG. 1C show the general principles of a basic implementation of the solution according to an embodiment of the present disclosure,

FIG. 2A-FIG. 2D show the general principles of a comprehensive implementation of the solution according to an embodiment of the present disclosure,

FIG. 3A-FIG. 3C show different examples of the comprehensive implementation of the solution according to an embodiment of the present disclosure,

FIG. 4 shows a schematic block diagram of an information technology infrastructure that may be used to implement the solution according to an embodiment of the present disclosure,

FIG. 5 shows the main software components that may be used to implement the solution according to an embodiment of the present disclosure,

FIG. 6A-FIG. 6G show an activity diagram describing the flow of activities relating to an implementation of the solution according to an embodiment of the present disclosure,

FIG. 7A-FIG. 7B show an exemplary dictionary that may be used to implement the solution according to an embodiment of the present disclosure,

FIG. 8 shows an exemplary inclusion proof that may be used to implement the solution according to an embodiment of the present disclosure, and

FIG. 9A-FIG. 9B show exemplary individual consistency proofs that may be used to implement the solution according to an embodiment of the present disclosure.

### DETAILED DESCRIPTION

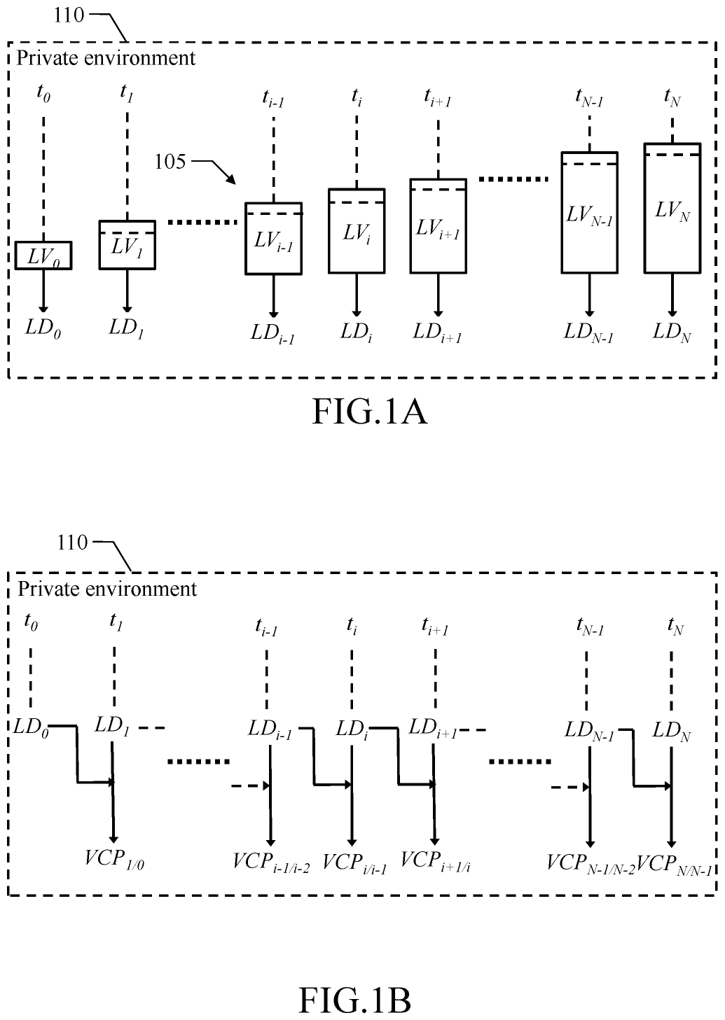

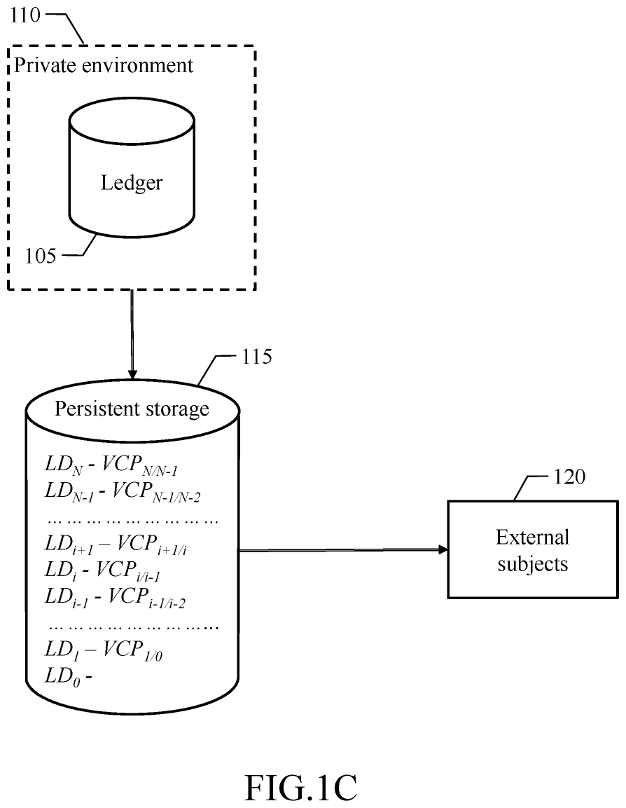

With reference now to FIG. 1A-FIG. 1C, the general principles are shown of a basic implementation of the solution according to an embodiment of the present disclosure.

Starting from FIG. 1A, a (private) ledger 105 is used to store generic data (for example, logs, documents, transactions, chats and so on) in a persistent way (with the data that may only be added in sequence by appending them to an end of the ledger 105 by one or more corresponding producers). Therefore, the ledger 105 accumulates the data that are never removed from the ledger 105 once they have been added thereto (with any updates of the data that preserve all previous values of the same data). The ledger 105 is produced in a private environment 110. For this purpose, access to the ledger 105 is restricted selectively only to authorized subjects that are entitled to know its content (for example, in a network of a private blockchain to corresponding producers participating thereto). The ledger 105 takes different (ledger) versions, which are generated over time as a result of the appending of corresponding data to the ledger 105. Particularly, for a temporal sequence of generic certification instants tᵢ following a creation of the ledger 105 (with i=0. . . N), corresponding (ledger) versions LVᵢ of the ledger 105 are provided.

Corresponding (ledger) digests LDᵢ based on the ledger versions LVᵢ are calculated (for example, by a certifier participating to the private blockchain as well). In general, each ledger digest LDᵢ is a value representative of the ledger version LVᵢ that is derived from its content (according to the data currently present therein). For example, the ledger digest LDᵢ is a hash value that is calculated by applying a cryptographic hash function. The cryptographic hash function is a hash function that maps input values of arbitrary size to hash values of fixed-size. In addition, the cryptographic hash function is deterministic, i.e., it always produces a same hash value from a same input value (with a low risk of collision given by the same hash value for different input values and with an avalanche effect producing extensive changes of the hash values for small changes of the input values); the cryptographic hash function is also non-invertible, i.e., with the hash values that may be calculated from the input values in a relatively fast way but with the input values that are practically infeasible to be calculated from the hash values (because of a computational complexity involving a time complexity longer than a relevance period of the input values, for example, not of polynomial time).

In the solution according to an embodiment of the present disclosure, verification information is calculated (for example, by the same certifier). The verification information is for verifying that the ledger 105 has a single consistent history, as defined by its ledger versions LVᵢ (for corresponding certification instants tᵢ up to a selected ledger version LVₛ for a selected certification instant tₛ along the corresponding sequence, i=0. . . s). The consistency of the history of the ledger 105 (once it has been created) means that the ledger version LVᵢ for each certification instants tᵢ, following the first one (i>0), contains the (preceding) ledger version LVᵢ₋₁ for the (preceding) certification instant tᵢ₋₁ immediately preceding it along the corresponding sequence without any alteration, and that the ledger version LVᵢ has been obtained by extending the preceding ledger version LVᵢ₋₁ (appending data to the end thereof). The verification information allows obtaining this result indirectly via computational operations, without the need of actually knowing the ledger versions LVᵢ.

Moving to FIG. 1B, in this specific implementation corresponding (version) consistency proofs VCP_{i/i-1} are calculated for the certification instants tᵢ following the first one (i>0); each version consistency proof VCP_{i/i-1} is for verifying (indirectly) the consistency of the ledger version LVᵢ with respect to the preceding ledger version LVᵢ₋₁ according to the corresponding ledger digests LDᵢ,LDᵢ₋₁ (without the need of actually knowing the ledger versions LVᵢ,LVᵢ₋₁).

Moving to FIG. 1C, the verification information is exposed outside the private environment 110 (for example, by the same certifier); at least part of the verification information for verifying an integrity thereof is stored into a (persistent) storage 115 of persist type (external to the private environment 110). The persistent storage 115 guarantees that a (stored) content thereof may not be altered once it has been stored therein, thereby making the stored content tamper-proof. This means that the persistent storage 115 is configured to make practically unfeasible tampering the stored content. Particularly, any altering of the stored content would require an effort higher than an importance thereof. Therefore, even if someone with enough resources (such as available time, computational power, skill, knowledge and/or instruments) might potentially manage to alter the stored content, the need to resort to these extreme measures (and a possible uncertainty of the obtained results) is a significant deterrent in practical circumstances; this frustrates any attempt of altering the stored content down to deter everybody from attempting it, thereby effectively preventing doing so. This result may be achieved by means of technical measures that substantially prevent the altering of the stored content (such as with a public blockchain); alternatively, the same result may be achieved by an authority being generally trusted that guarantees it. The information stored in the persistent storage ensures that the verification information is the same as when it was originally generated (i.e., that it relates to the history of the ledger 105 at the corresponding certification instant tᵢ). Particularly, in this specific implementation the verification information is defined by the ledger digests LDᵢ and the version consistency proofs VCP_{i/i-1}, and it is stored entirely into the persistent storage 115.

In this way, any (external) subjects 120 (for example, one or more consumers or auditors of the ledger 105) that are external to the private environment 110 may verify the ledger 105 according to the verification information. Particularly, this comprises verifying that each version consistency proof VCP_{i/i-1} is satisfied according to the corresponding ledger digests LDᵢ,LDᵢ₋₁. For this purpose, the version consistency proof VCP_{i/i-1} is used to calculate the (preceding ledger) digest LDᵢ₋₁ for the preceding certification instant tᵢ₋₁ thereby verifying that the preceding ledger version LVᵢ₋₁ is contained (unaltered) in the ledger version LVᵢ; moreover, the version consistency proof VCP_{i/i-1} is used to calculate the ledger digest LDᵢ thereby verifying that the ledger version LVᵢ has been obtained by extending the preceding ledger version LVᵢ₋₁. Moreover, there is verified that the ledger digest LDₛ for the selected certification instant tₛ is the same as the (selected) ledger digest LDₛ of the selected ledger version LVₛ. The persistent storage 115 guarantees that the ledger digests LDᵢ are tamper-proof. The version consistency proofs VCP_{i/i-1} are verified according to the (tamper-proof) ledger digests LDᵢ, thereby making the consistency of the (single) history of the ledger 105 tamper-evident.

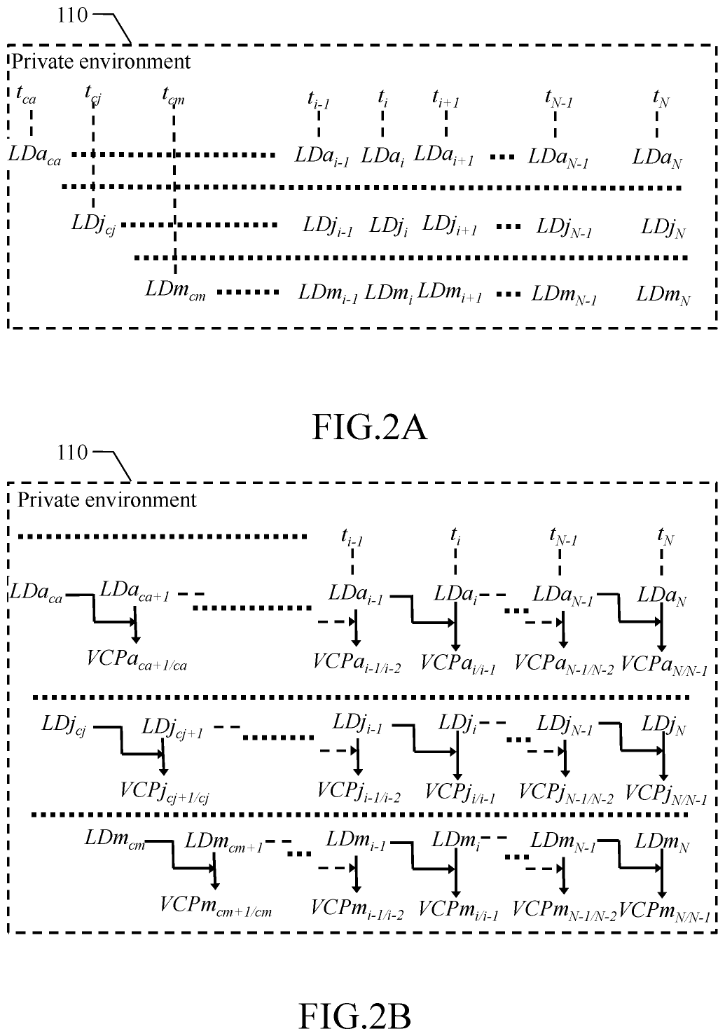

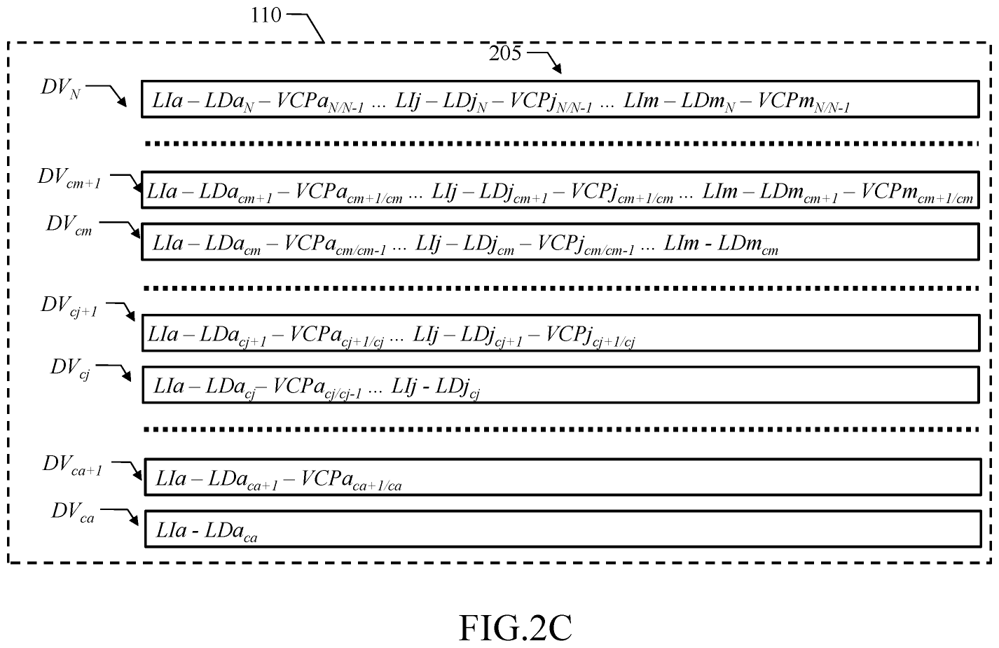

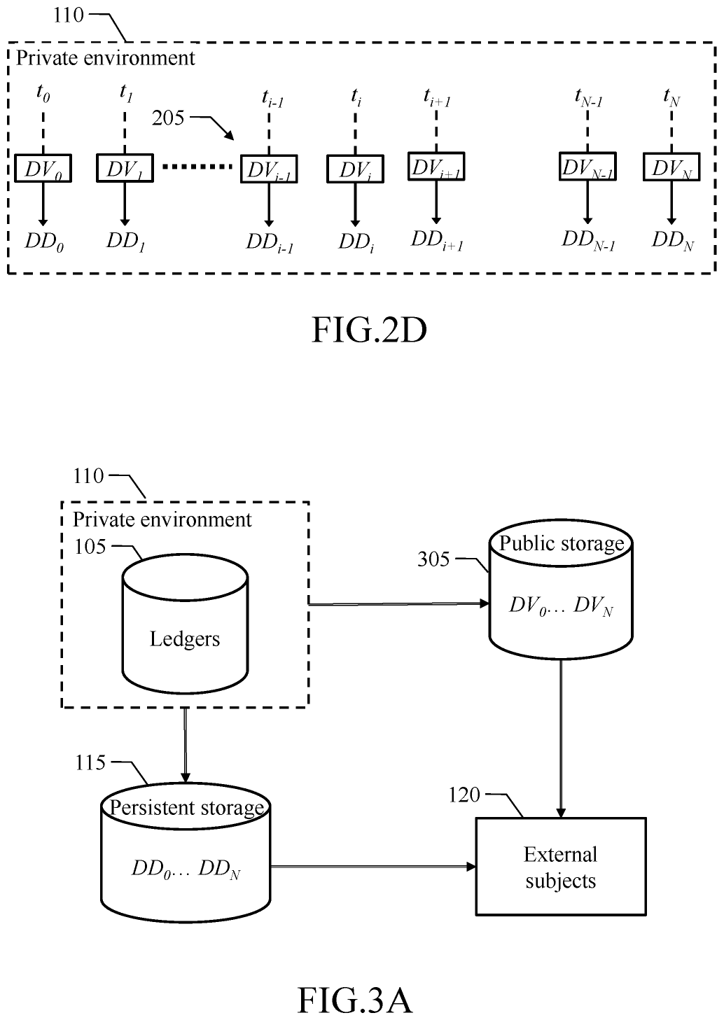

With reference now to FIG. 2A-FIG. 2D, the general principles are shown of a comprehensive implementation of the solution according to an embodiment of the present disclosure.

Starting from FIG. 2A, in this case a plurality of ledgers are produced in the same private environment 110. The ledgers are uniquely identified by corresponding (ledger) identifiers LIj (with j=a . . . m). As above, each ledger takes different (ledger) versions, which are generated over time as a result of the appending of corresponding data thereto. Particularly, for the same certification instants tᵢ (with i=0. . . N), corresponding ledger versions LVjᵢ of each j-th ledger are provided for the certification instants tᵢ starting from a (creation) certification instant t_{cj} of the j-th ledger corresponding to its creation (i≥cⱼ). Corresponding ledger digests LDjᵢ based on the ledger versions LVjᵢ of each j-th ledger are calculated. For example, each ledger digest LDjᵢ is calculated from the ledger version LVjᵢ containing the ledger identifier LIj (such as a hash value thereof).

In the solution according to an embodiment of the present disclosure, the verification information is then calculated (for example, again by the certifier). As above, the verification information is for verifying that each selected v-th ledger to be verified (identified by a selected ledger identifier LIv) has a single consistent history, as defined by its ledger versions LVvᵢ (for corresponding certification instants tᵢ up to a selected ledger version LVvₛ for a selected certification instant tₛ along the corresponding sequence, i=0. . . s); the verification information allows obtaining this result indirectly via computational operations, without the need of actually knowing the ledger versions LVvᵢ of the selected v-th ledger.

Moving to FIG. 2B, in this specific implementation, for each j-th ledger corresponding version consistency proofs VCPj_{i/i-1} are calculated for the certification instants tᵢ following the creation certification instant t_{cj} of the j-th ledger (i>cⱼ); as above, each version consistency proof VCPj_{i/i-1} is for verifying (indirectly) the consistency of the ledger version LVjᵢ with respect to the preceding ledger version LVjᵢ₋₁ according to the corresponding ledger digests LDjᵢ,LDjᵢ₋₁ (without the need of actually knowing the ledger versions LVjᵢ,LVjᵢ₋₁).

Moving to FIG. 2C, a dictionary 205 is built. The dictionary 205 takes different (dictionary) versions DVᵢ, which are generated over time for the certification instants tᵢ. Particularly, each dictionary version DVᵢ has corresponding (ledger) records for the (existing) ledgers that have already been created. The ledger record of each j-th ledger has an access key defined by the ledger identifier LIj; the ledger record contains the ledger digest LDjᵢ and the possible version consistency proof VCPj_{i/i-1} for the certification instant tᵢ (if following the creation certification instant t_{cj}, i>cⱼ).

The verification information is now based on the dictionary versions DVᵢ (and then indirectly on the ledger digests LDjᵢ and the version consistency profs VCPj_{i/i-1}). Particularly, the verification information is for verifying that the selected ledger identifier LIv of each selected v-th ledger to be verified, having a selected ledger digest LDvₛ of its selected ledger version LVvₛ, is excluded from the dictionary versions DVᵢ for any certification instants tᵢ preceding its creation certification instant tov and that the selected ledger identifier LIv is included in the dictionary versions DVᵢ for all the certification instants tᵢ starting from the creation certification instant t_{cv} up to the selected certification instant tₛ, with the dictionary version DVₛ for the selected certification instant tₛ that contains the selected ledger digest LDvₛ; moreover, for each certification instant tᵢ following the creation certification instant t_{cv}, the verification information is for verifying that the ledger version LVvᵢ is consistent with respect to the preceding ledger version LVvᵢ₋₁. The verification information allows obtaining this result indirectly via computational operations, without the need of actually knowing the ledger versions LVvᵢ.

In this case as well, the verification information is exposed outside the private environment 110 (for example, by the same certifier). At least part of the verification information for verifying integrity of the dictionary versions DVᵢ is stored into the same persistent storage (not shown in the figure), thereby making its stored content tamper-proof as above.

Moving to FIG. 2D, in a specific implementation corresponding (dictionary) digests DDᵢ based on the dictionary versions DVᵢ are calculated (such as by corresponding hash values). The dictionary digests DDᵢ are then stored into the persistent storage.

In this way, the same external subjects (not shown on the figure) may verify each selected v-th ledger according to the verification information. Particularly, this comprises verifying that the selected ledger identifier LIv is always excluded from the dictionary versions DVᵢ before the creation of the selected v-th ledger and is always included in the dictionary versions DVᵢ starting from its creation (with the dictionary version DVₛ for the selected certification instant tₛ that contains the selected ledger digest LDVₛ), and that the corresponding version consistency proofs VCPv_{i/i-1} are satisfied. The persistent storage guarantees that the dictionary digests DDᵢ are tamper-proof. This makes the dictionary versions DVᵢ, and then the consistency of the single history of the selected v-th ledger based thereon, tamper-evident.

Both the (basic/comprehensive) implementations of the solution according to an embodiment of the present disclosure allow the external subjects to verify that a single version of each ledger exists and that the data of the ledger have never been altered after their storing therein. The desired result is achieved even without any need of exposing the data of the ledgers outside the private environment. For example, in this way it is possible to verify the persistency of the ledgers by any subjects entrusted to audit the ledgers, to verify the persistency of the data exported from the private environment by any subject consuming them, the persistency of the data previously appended to the ledgers by any subjects invited to participate to the ledgers later on, and so on.

The verification information (to be exposed outside the private environment) has a size that is independent of the size of the ledgers. This substantially reduces any overloading of a corresponding network, with a beneficial effect on performance. Moreover, the proposed solution avoids disseminating the data. This is important when access to the data has to be controlled by restricting it selectively (especially when the data are subject to strict confidentiality requirements). The proposed solution is quite simple, thereby involving a relatively low consumption of networking, computational and storage resources.

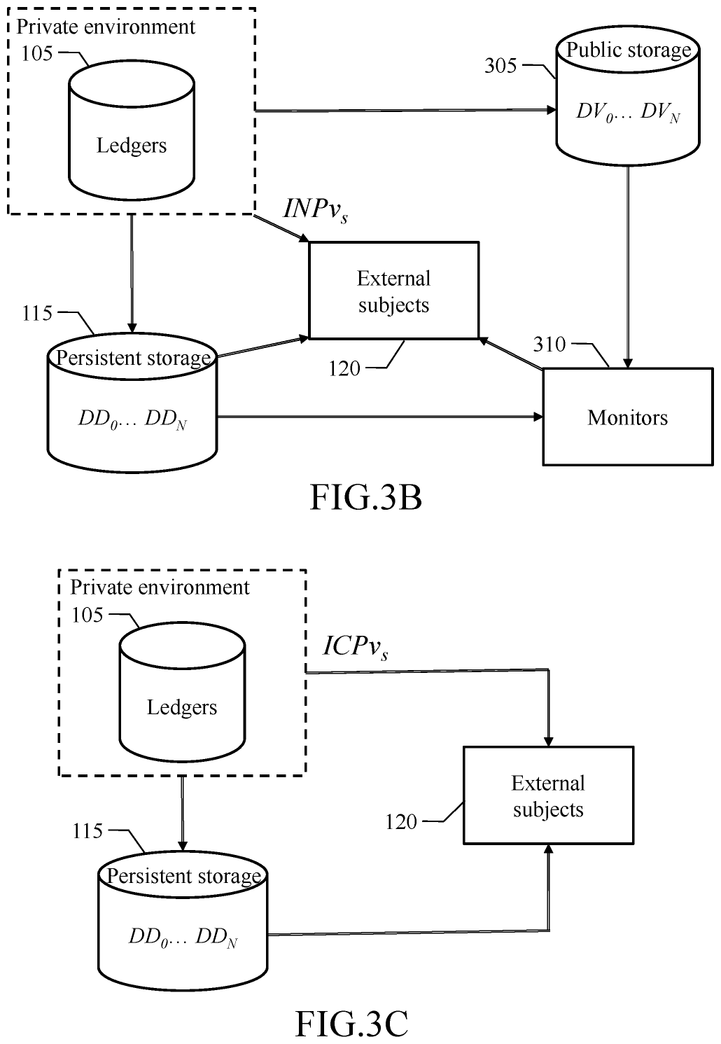

With reference now to FIG. 3A-FIG. 3C, different examples are shown of the comprehensive implementation of the solution according to an embodiment of the present disclosure.

Particularly, the verification information may comprise the dictionary digests DDᵢ and global consistency proofs GCPᵢ. The global consistency proofs GCPᵢ are defined for each certification instant tᵢ following a first certification instant t₀ (i>0). The global consistency proof GCPᵢ for each certification instant tᵢ is for verifying a global consistency of all the corresponding ledger versions LVjᵢ. Particularly, this means that all the ledger identifiers LIj included in the (preceding) dictionary version DVᵢ₋₁ for the preceding certification instant tᵢ₋₁ are included in the dictionary version DVᵢ as well and that the corresponding version consistency proofs VCPj_{i/i-1} are satisfied. For example, in a simple implementation the global consistency proofs GCPjᵢ are defined by the dictionary versions DVᵢ themselves. Alternatively, only the dictionary digests DDᵢ are stored into the persistent storage (so as to reduce the amount of data to be stored therein, especially when the persistent storage is a public blockchain). In this case, the rest of the verification information may be exposed outside the private environment in different ways.

For example, starting from FIG. 3A, the verification information comprises the dictionary digests DDᵢ (stored in the persistent storage 115) and the (entire) dictionary versions DVᵢ. The dictionary versions DVᵢ are published into a generic (public) storage 305, external to the private environment 110 as well (for example, in a cloud environment). In this way, the external subjects 120 may verify the persistency of the dictionary versions DVᵢ according to their dictionary digests DDᵢ from the persistent storage 115. The external subjects 120 may then verify an individual consistency of the selected ledger version LVvₛ directly in the dictionary versions DVᵢ. Particularly, this means that if the selected ledger identifier LIv is included in any of the dictionary versions DVᵢ for a corresponding certification instant tᵢ preceding the selected certification instant tₛ along the corresponding sequence (i<s), the selected ledger identifier LIv is included in the (following) dictionary version DVᵢ₊₁ for the (following) certification instant tᵢ₊₁ following it as well, that the corresponding version consistency proof VCPv_{i+1/i} is satisfied and that the selected ledger version LVvₛ is included in the dictionary version DVₛ for the selected certification instant tₛ.

Moving to FIG. 3B, as above the verification information comprises the dictionary digests DDᵢ (stored in the persistent storage 115) and the dictionary versions DVᵢ (published in the public storage 305). In this case, however, one or more monitors 310 verify the persistency of the dictionary versions DVᵢ according to their dictionary digests DDᵢ in the persistent storage 115 and their global consistency (i.e., that all the ledger identifiers LIj included in the possible preceding dictionary version DVᵢ₋₁ are included in the dictionary version DVᵢ as well and that the corresponding version consistency proofs VCPj_{i/i-1} are satisfied) directly in the dictionary versions DVᵢ. The monitors 130 certify a result of this verification to the external subjects 120. Therefore, each external subject 120 trusting one or more of the monitors 310 may achieve the same result indirectly. In this case, the verification information further comprises an inclusion proof INPvₛ (for each selected ledger identifier LIv and its selected ledger digest LDvₛ) that is provided to the external subjects 120. The inclusion proof INPvₛ is for verifying that the selected ledger identifier LIv and the selected ledger digest LDvₛ are included in the dictionary version DVₛ for the selected certification instant tₛ according to the dictionary digests DDᵢ (without the need of actually knowing the dictionary versions DVᵢ).

Moving to FIG. 3C, the verification information comprises the dictionary digests DDᵢ (stored in the persistent storage 115) and an individual consistency proof ICPvₛ (for each selected ledger identifier LIv and its selected ledger digest LDvₛ) that is provided to the external subjects 120. The individual consistency proof ICPvₛ is for verifying the individual consistency of the corresponding selected ledger version LVvₛ (i.e., that if the selected ledger identifier LIv is present in any dictionary version DVᵢ (i<s) it is present in the possible following dictionary version DVᵢ₊₁ as well, that the corresponding version consistency proof VCPv_{i+1/i} is satisfied and that the selected ledger version LVvₛ is included in the dictionary version DVₛ for the selected certification instant tₛ) indirectly according to the dictionary digests DDᵢ (without the need of actually knowing the dictionary versions DVᵢ).

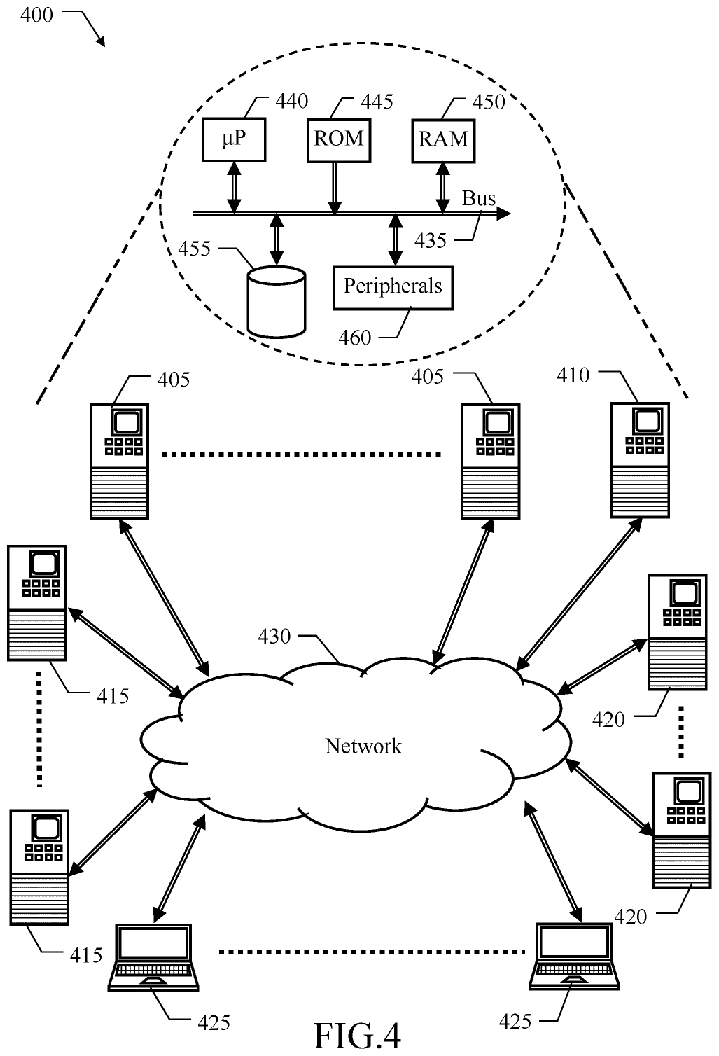

With reference now to FIG. 4, a schematic block diagram is shown of an information technology infrastructure 400 that may be used to implement the solution according to an embodiment of the present disclosure.

The (information technology) infrastructure 400 comprises one or more computing systems, or simply producer nodes 405 of the producers of the ledgers and a computing system, or simply certification node 410 (or more) of the certifier of the ledgers (for example, all of them participating to the private blockchains implementing the ledgers). The infrastructure 400 further comprises one or more computing systems, or simply storage servers 415 that implement the persistent storage (not shown in the figure); for example, the storage servers 415 are miners of a corresponding public blockchain or belong to a generally trusted authority. In the corresponding implementation, the infrastructure 400 may also comprise one or more computing systems, or simply monitor servers 420 of the monitors. Moreover, the infrastructure 400 comprises one or more computing systems, or simply external clients 425 of the external subjects (for example, corresponding consumers or auditors of the ledgers). The computing systems 405-425 communicate among them overa (telecommunication) network 430, for example, of global type based on the Internet.

Each of the above-described computing systems (producer nodes 405, certification node 410, storage servers 415, monitoring servers 420 and external clients 425) comprises several units that are connected among them through a bus structure 435 at one or more levels (with an architecture that is suitably scaled according to the type of the computing system 405-425). Particularly, a microprocessor (μP) 440, or more, provides a logic capability of the computing system 405-425; a non-volatile memory (ROM) 445 stores basic code for a bootstrap of the computing system 405-425 and a volatile memory (RAM) 450 is used as a working memory by the microprocessor 440. The computing system 405-425 is provided with a mass-memory 455 for storing programs and data (for example, storage devices of a data center wherein each node/server 405-420 is implemented and a Solid-State Disk, or SSD, for each client 425). Moreover, the computing system 405-425 comprises a number of controllers for peripherals, or Input/Output (I/O) units, 460; for example, the peripherals 460 of each node/server 405-420 comprise a network adapter for plugging the node/server 405-420 into the corresponding data center and then connecting it to a console of the data center for its control (for example, a personal computer, also provided with a drive for reading/writing removable storage units, such as of USB type) and to a switch/router sub-system of the data center for its communication with the network 430, whereas the peripherals 460 of each client 425 comprise a keyboard, a mouse, a monitor, a network adapter for connecting to the network 430 and a drive for reading/writing removable storage units (such as of USB type).

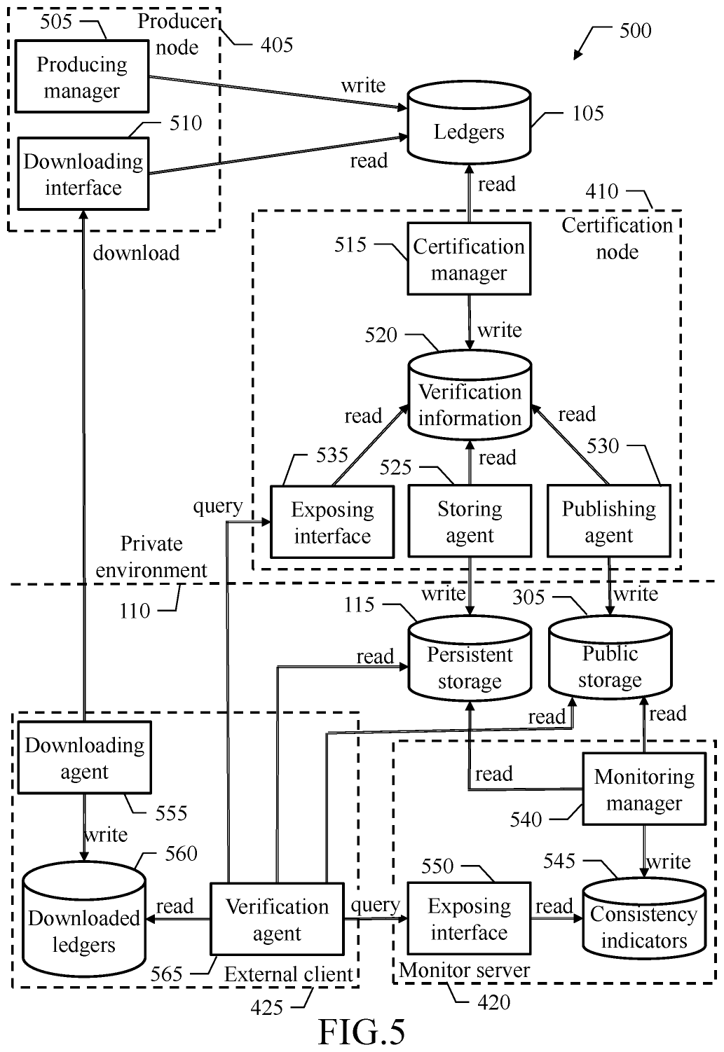

With reference now to FIG. 5, the main software components are shown that may be used to implement the solution according to an embodiment of the present disclosure.

Particularly, all the software components (programs and data) are denoted as a whole with the reference 500. The software components are typically stored in the mass memory and loaded (at least partially) into the working memory of each computing system when the programs are running, together with an operating system and other application programs not directly relevant to the solution of the present disclosure (thus omitted in the figure for the sake of simplicity). The programs are initially installed into the mass memory, for example, from removable storage units or from the network. In this respect, each program may be a module, segment or portion of code, which comprises one or more executable instructions for implementing the specified logical function.

Starting from each producer node 405 (only one shown in the figure) it comprises the following components. A producing manager 505 produces the ledgers 105 by writing them. For example, each ledger 105 is implemented as a private blockchain. The private blockchain is formed by a temporal sequence of blocks; each block contains corresponding data to be stored and a hash value of a preceding block in the sequence (null for a first, or genesis, block containing service information comprising the corresponding ledger identifier LIj). The blocks are added to the blockchain once a consensus has been reached among all the producer nodes 405 of the corresponding network; for example, in a consensus schema based on selective endorsement each producer node 405 verifies that each new block contains the appropriate number of endorsements and that they are from the expected producer nodes 405 (as specified in an endorsement policy). A downloading interface 510 exposes the ledgers 105 for downloading thereof upon request (outside the private environment 110) by reading them.

Moving to the certification node 410, it comprises the following components. A certification manager 515 generates the verification information to be used to verify the ledgers 105 (i.e., their single consistent histories). The certification manager 515 reads the ledgers 105 and it writes a verification information repository 520. The verification information repository 520 stores information functional to the generation of the verification information (for example, the dictionary versions DVᵢ in the comprehensive implementation). A storing agent 525 stores at least part of the verification information read from the corresponding repository 520 into the persistent storage 115 by writing it via the corresponding storage servers, not shown in the figure (for example, the ledger digests LDᵢ and the version consistency proofs VCP_{i/i-1} in the basic implementation or the dictionary digests DDᵢ in the comprehensive implementation). An optional publishing agent 530 publishes the dictionary versions DVᵢ read from the verification information repository 520 into the public storage 305 by writing it. An optional exposing interface 535 exposes the inclusion proof INPvₛ or the individual consistency proof ICPvₛ for each selected v-th ledger to be verified outside the private environment 110, as generated according to the dictionary versions DVᵢ read from the verification information repository 520.

Moving to each possible monitor server 420 (only one shown in the figure), it comprises the following components. A monitoring manager 540 monitors the dictionary versions DVᵢ read from the public storage 305 to verify them according to the dictionary digests DDᵢ read from the persistent storage 115. The monitoring manager 540 writes a global consistency indicator repository 545, which stores global consistency indicators GCIᵢ for the certification instants tᵢ. Each global consistency indicators GCIᵢ is asserted when the monitoring manager 540 has verified the integrity and the global consistency of the corresponding dictionary version DVᵢ, whereas it is deasserted otherwise. An exposing interface 550 exposes the global consistency indicators GCIᵢ read from the corresponding repository 545.

Moving to each external client 425 (only one shown in the figure), it comprises the following components. A downloading agent 555 downloads each selected ledger version LVvₛ from the private environment 110 via the downloading interface 510 of one or more producer nodes 405 (as authorized by an owner of the corresponding selected v-th ledger). The downloading agent 555 writes a downloaded ledger repository 560, which stores a local copy of each selected ledger version LVvₛ that has been downloaded. A verification agent 565 verify that each (downloaded) selected ledger version LVvₛ read from the corresponding repository 560 has a single consistent history. For this purpose, the verification agent 565 reads the persistent storage 115 (for the corresponding verifications information); moreover, the verification agent 565 may read the public storage 305 (for the dictionary versions DVᵢ), may query the exposing interface 550 of the monitor servers 420 (for the global consistency indicators GCIᵢ) and/or may query the exposing interface 535 of the certification node 410 (for the corresponding inclusion proof INPvₛ or individual consistency proof ICPvₛ).

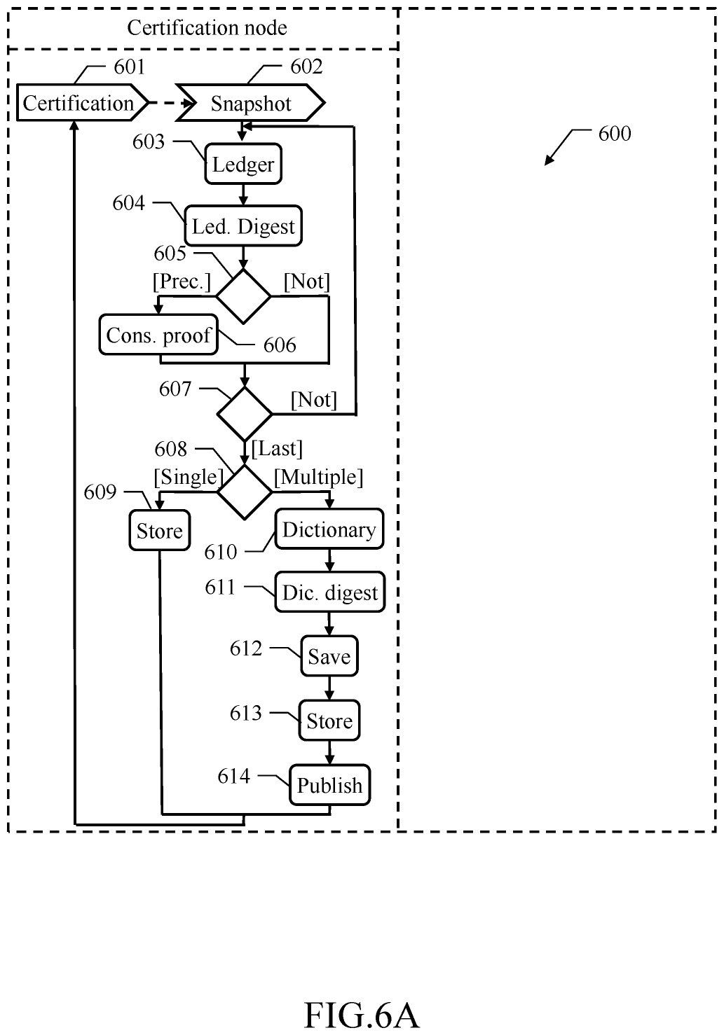

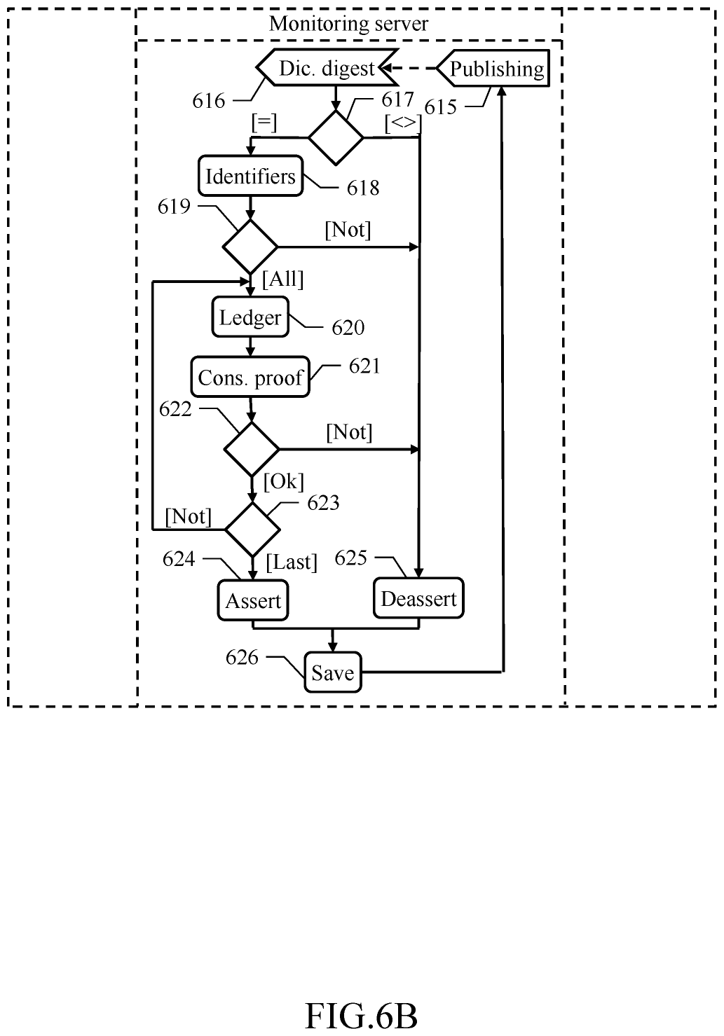

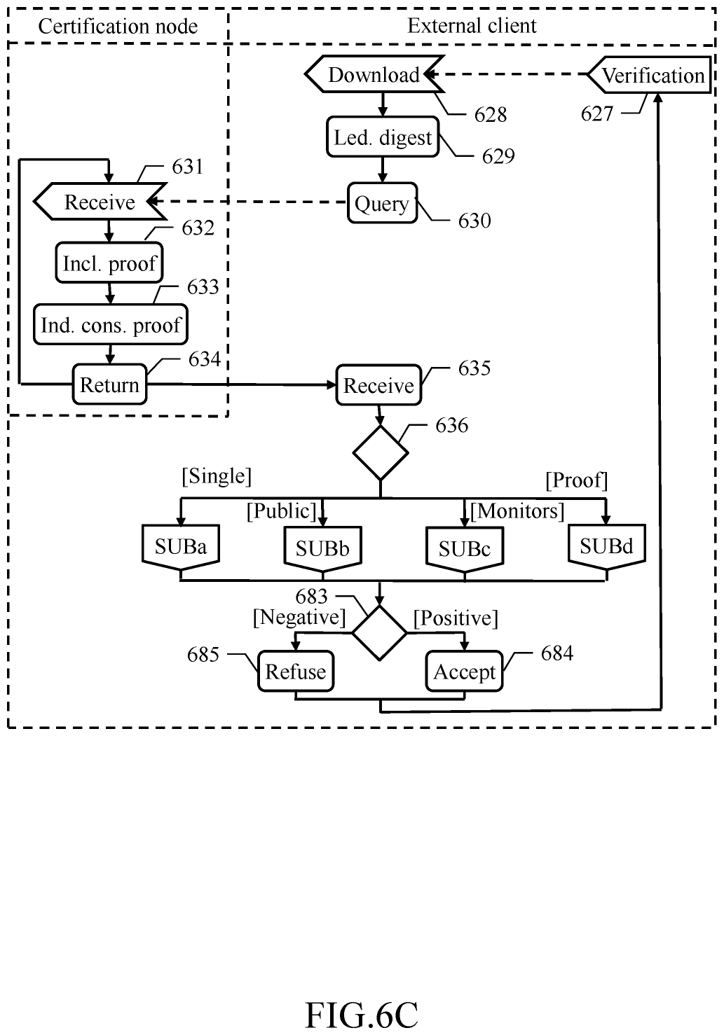

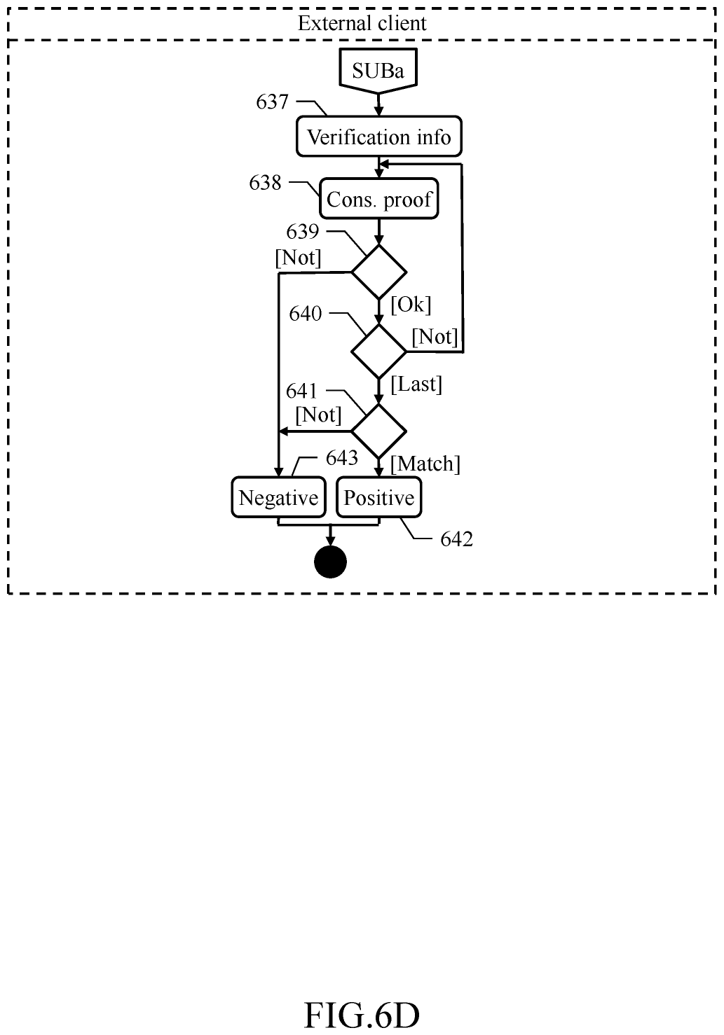

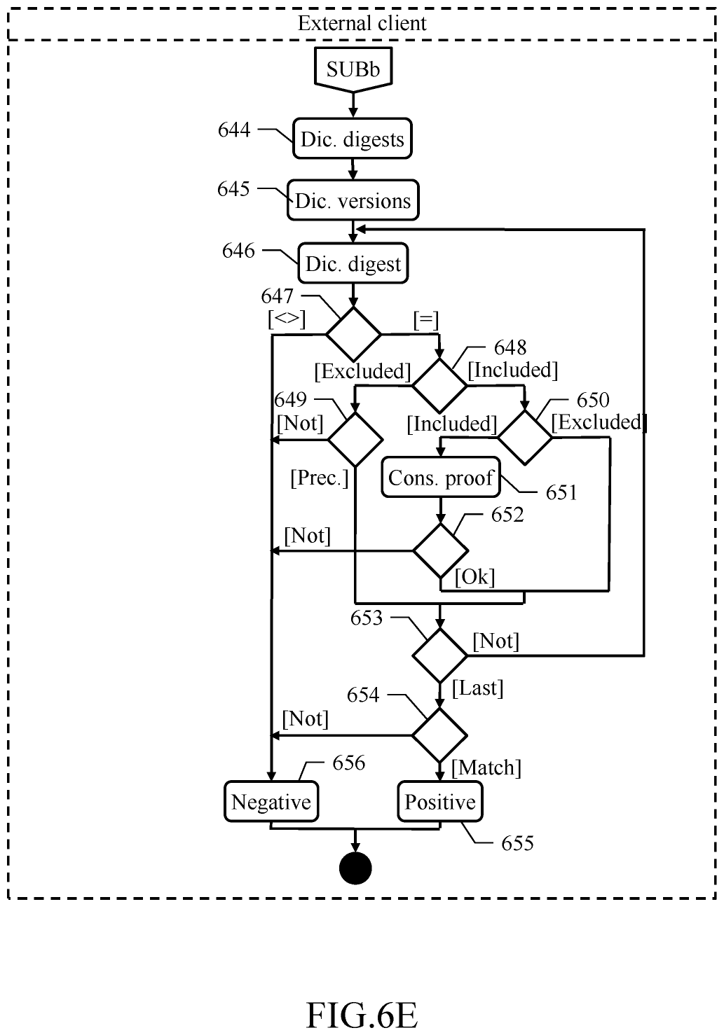

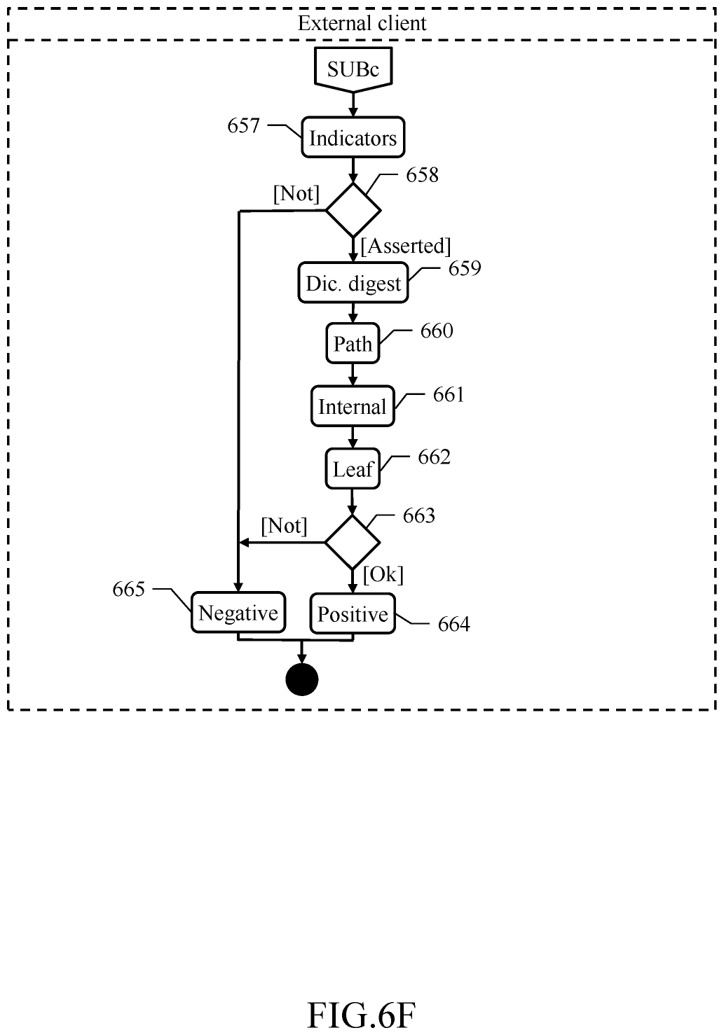

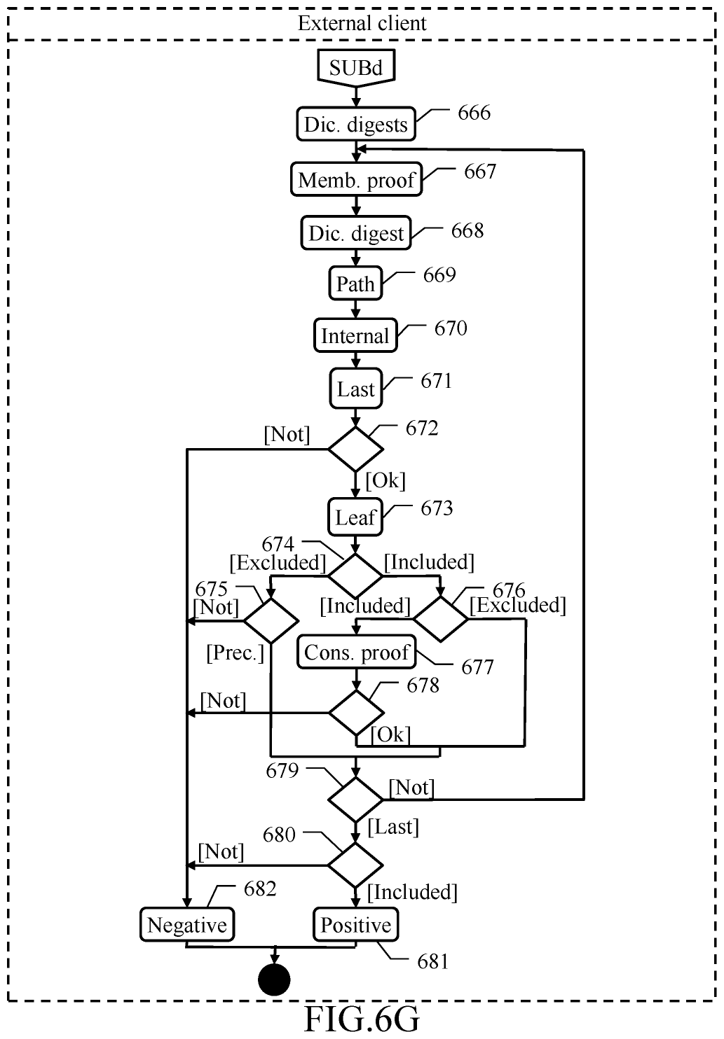

With reference now to FIG. 6A-FIG. 6G, an activity diagram is shown describing the flow of activities relating to an implementation of the solution according to an embodiment of the present disclosure.

Particularly, the diagram represents an exemplary process that may be used to certify the data stored in the ledgers with a process 600. In this respect, each block may correspond to one or more executable instructions for implementing the specified logical function on the relevant computing system.

The process passes from block 601 to block 602 in the swim-lane of the certification node in response to every (current) certification instant tᵢ (for example, periodically, such as every night). At this point, the certification manager takes a snapshot of the (current) ledger versions LVjᵢ for the certification instant tᵢ of all the ledgers that have already been created at the moment. A loop is then entered at block 603, wherein the certification manager takes the (current) ledger version LVjᵢ of a (current) j-th ledger into account (starting from a first one in any arbitrary order). The certification manager at block 604 calculates the (current) ledger digest LDjᵢ of the ledger version LVjᵢ. For example, the ledger digest LDᵢ is calculated as the Merkle tree root hash of the blocks of the ledger version LVjᵢ (containing the corresponding ledger identifier LIj). For this purpose, the hash values of the blocks are arranged into a Merkle tree, which is a binary tree having its leaf nodes labelled with the hash values of the blocks, in the same order of their succession in the ledger version LVjᵢ. Each inner node of the Merkle tree is labelled with the hash value of the concatenation of the hash values of its child nodes, up to the hash value of a root node of the Merkle tree that defines the ledger digest LDᵢ. The flow of activity branches at block 605 according to a status of the j-th ledger for the preceding certification instant tᵢ₋₁, if any. Particularly, this depends on a cardinality of the certification instant tᵢ and further, in the comprehensive implementation, on a search for the ledger identifier LIj in the preceding dictionary version DVᵢ₋₁ (in the verification information repository). Particularly, the process continues to block 606 if the j-th ledger already existed for the preceding certification instant tᵢ₋₁; this occurs in the basic implementation for every certification instant tᵢ following the first certification instant t₀ (i>0) and in the comprehensive implementation further when the ledger identifier LIj is included in the preceding dictionary version DVᵢ₋₁. In this case, the certification manager at block 606 calculates the corresponding version consistency proof VCP_{i/i-1}. In the example at issue, the version consistency proof VCP_{i/i-1} may be the corresponding Merkle consistency proof. The Merkle consistency proof is defined by the minimum set of hash values in the Merkle tree of the ledger version LVᵢ that are required to verify that the ledger version LVᵢ contains the preceding ledger version LVᵢ₋₁ without any alteration and that the ledger version LVᵢ has been obtained by extending the preceding ledger version LVᵢ₋₁ (appending one or more blocks to the end thereof). The flow of activity merges again at block 607 from block 606 of directly from block 604 if the j-th ledger did not exist for the preceding certification instant tᵢ₋₁ (always true for the first certification instant t₀ or when the ledger identifier LIj is excluded from the preceding dictionary version DVᵢ₋₁ in the comprehensive implementation). At this point, the certification manager verifies whether a last ledger has been processed. If not, the flow of activity returns to block 603 to repeat the same operations on a next ledger.

Conversely, once all the ledgers have been process, the flow of activity branches at block 608 according to the implementation of the solution according to an embodiment of the present disclosure. Particularly, in the basic implementation (single ledger) the storing agent at block 609 stores the (new) piece of certification information for the certification instant tᵢ, defined by the ledger digest LDᵢ and the possible version consistency proof VCP_{i/i-1}, into the persistent storage (by appending it thereto). Conversely, in the comprehensive implementation (multiple ledgers) the certification manager at block 610 builds the corresponding (current) dictionary version DVᵢ. For example, the dictionary is formed by a search tree, for example, of binary type. The search tree is a graph (nodes and edges linking them) with at most a single edge between each pair of nodes. The nodes descend from a root node, with each node having at most two (left/right) child nodes descending therefrom via corresponding (left/right) edges. Each edge is identified by a label given by a binary value, for example, 0 for the left edges and 1 for the right edges. Each node is then identified by a search key given by a sequence of the labels of the edges in a search path from the root node to this node. The ledger record of each j-th ledger is associated with a corresponding leaf node (having no child node), whose search key is equal to the shortest beginning of the ledger identifier LIj that is required to identify the j-th ledger uniquely in the search tree (i.e., a prefix of the ledger identifier LIj up to its entirety); the leaf node contains the (full) ledger identifier LIj, the ledger digest LDjᵢ and the possible version consistency proof VCPj_{i/i-1}. Each internal node (having one or more child nodes) instead has a left field and a right field; the left field and the right field contain the hash values of the corresponding left child node and right child node, respectively, if any (or a null value otherwise). In this case, the certification manager builds the dictionary version DVᵢ by determining the search keys of the ledgers (shortest prefix of the ledger identifiers LIj being required to identify them uniquely) and then creating the corresponding leaf nodes; for each level of the search tree moving upwards from the one immediately above the lowest level of these leaf nodes up to the root node, the certification manager then creates the corresponding internal nodes. The storing agent at block 611 calculates the (current) dictionary digest DDᵢ of the dictionary version DVᵢ. For example, the dictionary digest DDᵢ is calculated as the hash value of the concatenation of the hash value of the root node of the dictionary version DVᵢ with the (preceding) dictionary digest DDᵢ₋₁ for the preceding certification instant tᵢ₋₁, if any.

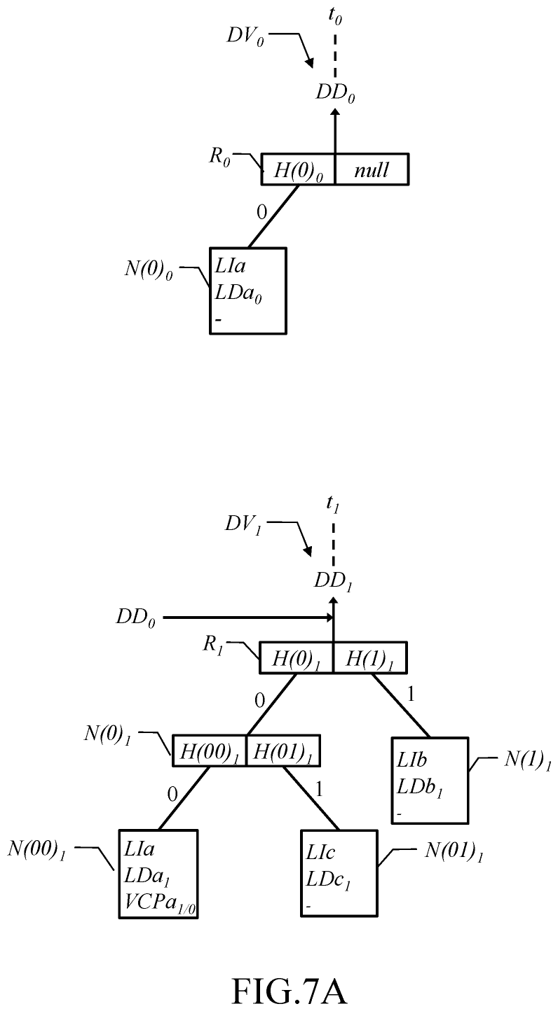

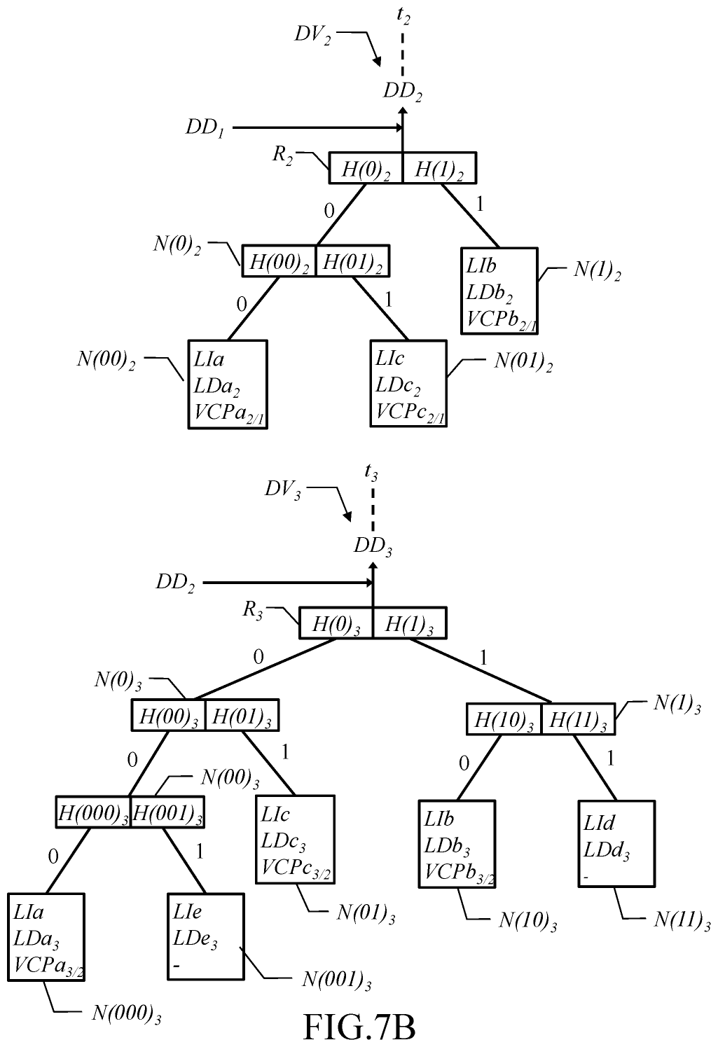

With reference to FIG. 7A-FIG. 7B, an exemplary dictionary is shown that may be used to implement the solution according to an embodiment of the present disclosure.

Particularly, the figure show the dictionary versions DV₀-DV₃ of a very simple dictionary for the certification instants t₀-t₃.

Starting from the certification instant t₀, a ledger A has been created, with the ledger identifier LIa=“00000000” and the ledger digest LDa₀. The shortest prefix of the ledger identifier L1a being required to identify it is “0”. Therefore, the search tree comprises a root node R₀ with a left child node N(0)₀ that defines the leaf node associated with the ledger A (search path=“0”). The node N(0)₀ contains the ledger identifier L1a and the ledger digest LDa₀ of the ledger A (no version consistency proof). The root node R₀ contains the hash value H(0)₀ of the node N(0)₀ in the left field and the null value in the right field. The dictionary digest DD₀ is equal to the hash value of the root node R₀ (no preceding dictionary digest).

Moving to the certification instant t₁, the ledger A now has the ledger digest LDa and the version consistency proof VCPa_{1/0}. Moreover, two further ledgers have been created, a ledger B with the ledger identifier LIb=“10000000” and the ledger digest LDb₁, and a further ledger C with the ledger identifier LIc=“01000000” and the ledger digest LDc₁. The shortest prefixes of the ledger identifiers LIa, LIb and LIc being required to identify them are “00”, “1” and “01”, respectively. Therefore, the search tree comprises a root node Ry with a left child node N(0)₁ and a right child node N(1)₁; the node N(0)₁ has a left child node N(00)₁ that defines the leaf node associated with the ledger A (search path=“00”) and a right child node N(01)₁ that defines the leaf node associated with the ledger C (search path=“01”), whereas the node N(1)₁ defines the leaf node associated with the ledger B (search path=“1”). The dictionary digest DD₁ is equal to the hash value of the concatenation of the preceding dictionary digest DD₁ with the hash value of the root node R₁.

Moving to the certification instant t₂, the ledger A now has the ledger digest LDa₂ and the version consistency proof VCPa_{2/1}, the ledger B now has the ledger digest LDb₂ and the version consistency proof VCPb_{2/1}, and the ledger C now has the ledger digest LDc₂ and the version consistency proof VCPc_{2/1} (no further ledger has been added). Therefore, the search tree comprises a root node R₂ with a left child node N(0)₂ and a right child node N(1)₂; the node N(0)₂ has a left child node N(00)₂ that defines the leaf node associated with the ledger A (search path=“00”) and a right child node N(01)₂ that defines the leaf node associated with the ledger C (search path=“01”), whereas node N(1)₂ defines the leaf node associated with the ledger B (search path=“1”). The dictionary digest DD₂ is equal to the hash value of the concatenation of the preceding dictionary digest DD₁ with the hash value of the root node R₂.

Moving to the certification instant t₃, the ledger A now has the ledger digest LDa₃ and the version consistency proof VCPa_{3/2}, the ledger B now has the ledger digest LDb₃ and the version consistency proof VCPb_{3/2}, and the ledger C now has the ledger digest LDc₃ and the version consistency proof VCPC_{3/2}. Moreover, two further ledgers have been created, a ledger D with the ledger identifier LId=“11000000” and the ledger digest LDd₃, and a ledger E with the ledger identifier LIe=“00100000” and the ledger digest LDe₃. The shortest prefixes of the ledger identifiers LIa, LIb, LIc, LId and LIe being required to identify them are “000”, “10”, “01”, “11” and “001”, respectively. Therefore, the search tree now comprises a root node R₃ with a left child node N(0)₃ and a right child node N(1)₃. The node N(0)₃ has a left child node N(00)₃, with a left child node N(000)₃ that defines the leaf node associated with the ledger A (search path=“000”) and a right child node N(001)₃ that defines the leaf node associated with the ledger E (search path=“001”); moreover, the node N(0)₃ has a right child node N(01)₃ that defines the leaf node associated with the ledger C (search path=“01”). The node N(1)₃ has a left child node N(10)₃ that defines the leaf node associated with the ledger B (search path=“10”) and a right child node N(11)₃ that defines the leaf node associated with the ledger D (search path=“11”). The dictionary digest DD₃ is equal to the hash value of the concatenation of the preceding dictionary digest DD₂ with the hash value of the root node R₃.

Referring back to FIG. 6A, the certification manager at block 612 saves the dictionary version DVᵢ, as defined by a serialization of its search tree in the example at issue, into the verification information repository (by appending it thereto). The storing agent at block 613 stores the (current) piece of verification information, as defined by the dictionary digest DDᵢ, into the persistent storage (by appending it thereto). If necessary, the publishing agent at block 614 publishes the dictionary version DVᵢ into the public storage (by appending it thereto). The process then returns from block 609 or from block 614 to block 601 waiting for a next certification instant tᵢ.

In the implementation based on the monitors, the process passes from block 615 to block 616 in the swim-lane of each monitoring server (only one shown in the figure) in response to the publication of every dictionary version DVᵢ into the public storage (for example, detected by the monitoring manager checking it continually or receiving a corresponding notification). At this point, the monitoring manager calculates the dictionary digest DDᵢ of the dictionary version DVᵢ as above. The flow of activity branches at block 617 according to a comparison between the (calculated) value of the dictionary digest DDᵢ being calculated and the (stored) value of the dictionary digest DDᵢ being stored in the persistent storage. If the calculated value and the stored value match (confirming integrity of the dictionary version DVA), the monitoring manager at block 618 compares the (current) ledger identifiers LIj of the (current) ledgers that are present in the dictionary version DVᵢ and the (preceding) ledger identifiers LIj of the (preceding) ledgers that are present in the preceding dictionary version DVᵢ₋₁, if any (as indicated in the public storage). The flow of activity branches at block 619 according to a result of this comparison. If all the ledger identifiers LIj that are present in the preceding dictionary version DVᵢ₋₁ are present in the dictionary version DVᵢ as well (always true for the first certification instant t₀), the process continue to block 620. At this point, a loop is entered wherein the monitoring manager takes a (common) j-th ledger, being present in both the dictionary versions DVᵢ₋₁ and DVᵢ, into account (starting from a first one in any arbitrary order). The monitoring manager at block 621 verifies the corresponding version consistency proof VCPj_{i/i-1} according to the corresponding ledger digests LDᵢ,,LDᵢ₋₁ (from the dictionary versions DVᵢ,DVᵢ₋₁ in the public storage), by using the version consistency proof VCPj_{i/i-1} to calculate the ledger digests LDᵢ,LDᵢ₋₁ and then verifying that they match the corresponding expected values. The flow of activity branches at block 622 according to a result of this verification. If the version consistency proof VCPj_{i/i-1} is satisfied, the monitoring manager at block 623 verifies whether a last common ledger has been processed. If not, the flow of activity returns to block 620 to repeat the same operations for a next common ledger. Conversely, once all the common ledgers have been process, the monitoring manager at block 624 asserts the corresponding global consistency indicator GCIᵢ. Conversely, the process passes to block 625 from block 617 (if the calculated value and the stored value of the dictionary digest DDᵢ differ), from block 619 (if one or more ledger identifiers LIj present in the preceding dictionary version DVᵢ₋₁ are not present in the dictionary version DVᵢ) or from block 622 (if the version consistency proof VCPj_{i/i-1} is not satisfied). In this case, the monitoring manager deasserts the global consistency indicator GCIᵢ. The flow of activity merges again at block 626 from block 624 or from block 625, wherein the monitoring manager saves the global consistency indicator GCIᵢ into the corresponding repository (by appending it thereto). The process then returns to block 615 waiting for the publication of a next dictionary version DVᵢ into the public storage.

In a completely independent way, the process pass from block 627 to block 628 in the swim-lane of each external client (only one shown in the figure) whenever each selected ledger version LVvₛ has to be verified of a selected v-th ledger (having a selected ledger identifier LIv) for a selected certification instant tₛ (for example, a last one available by default) by an auditor or a consumer, the selected ledger being the only one available in the basic implementation. In response thereto, the downloading agent downloads the selected ledger version LVvₛ from the downloading interface of a producer node thereof and saves it into the corresponding repository. The verification agent at block 629 calculates the selected ledger digest LDvₛ of the selected ledger version LVvₛ as above. Alternatively (for example, in case of the external client of an auditor entrusted to verify the selected v-th ledger without disclosing its content), the verification agent directly receives the selected ledger digest LDvₛ from the exposing interface of the certification node (without any knowledge of the selected ledger version LVvₛ).

If necessary, the verification agent at block 630 queries the certification node for the corresponding inclusion proof INPvₛ or individual consistency proof ICPvₛ. Moving of the swim-lane of the certification node, the exposing interface receives the query at block 631 (being in a listening condition for it). In response thereto, the exposing interface at block 632 generates the inclusion proof INPvₛ (if required). In case the dictionary is in the form of the above-described search tree, the inclusion proof INPvₛ is defined by a serialization of a tree path comprising all the nodes of the corresponding search tree along the longest search path defined by the prefix of the selected ledger identifier LIv (up to its entirety).

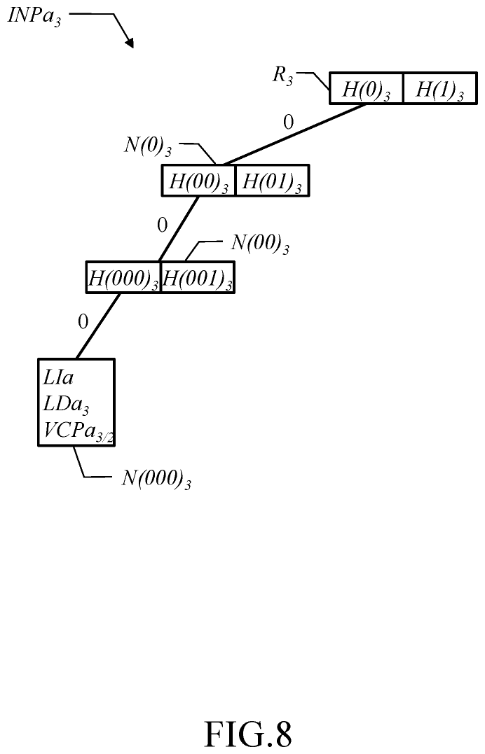

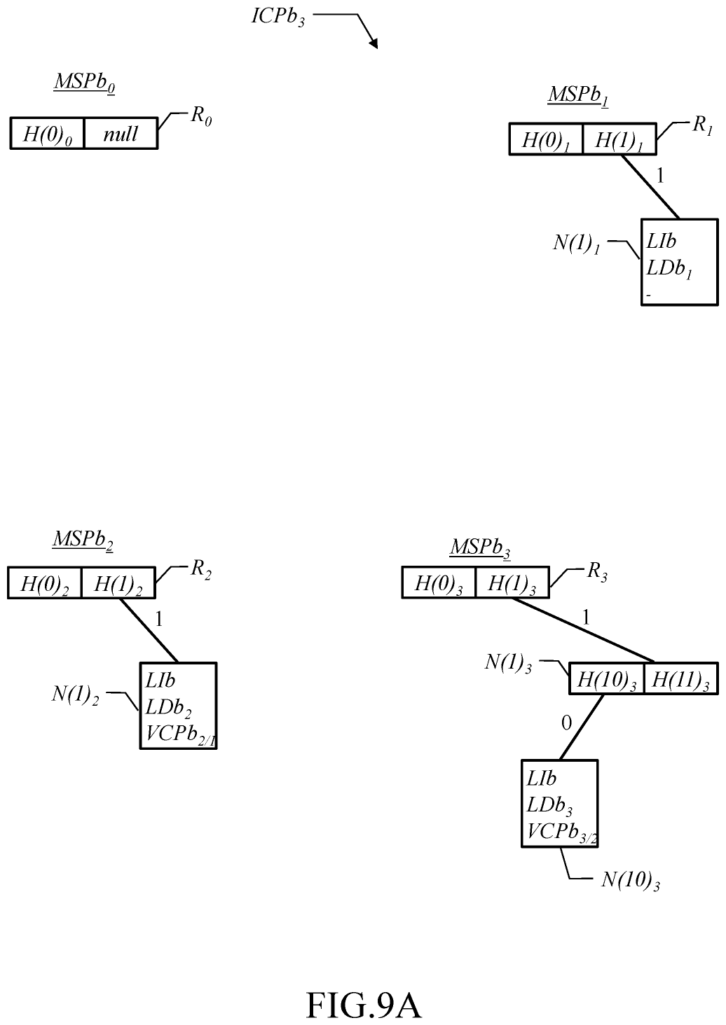

With reference to FIG. 8, an exemplary inclusion proof is shown that may be used to implement the solution according to an embodiment of the present disclosure. Particularly, with reference to the dictionary version DV₃ shown in FIG. 7B, the inclusion proof INPa₃ of the selected ledger identifier LIa=“00000000” and the selected ledger digest LDa₃ (ledger A) is defined by the nodes R₃, N(0)₃, N(00)₃ and N(000)₃.

Referring back to FIG. 6C, the exposing interface at block 633 generates the individual consistency proof ICPvₛ (if required). For example, the individual consistency proof ICPvₛ is defined by a temporal sequence of corresponding membership (exclusion/inclusion) proofs MSPvᵢ (for the certification instants tᵢ up to the selected certification instant tₛ, i=0 . . . s). Each membership proof MSPvᵢ is for verifying that the selected ledger identifier LIv is excluded from the corresponding dictionary version DVᵢ (exclusion proof) or that the selected ledger identifier LIv with the ledger digest LDvᵢ for the corresponding certification instant tᵢ is included in the corresponding dictionary version DVᵢ (inclusion proof); this result is achieved according to the dictionary digests DDᵢ (without the need of actually knowing the dictionary versions DVᵢ). In case the dictionary is in the form of the above-described search tree, each membership proof MSPvᵢ is again defined by the serialization of the tree path comprising all the nodes of the corresponding search tree along the longest search path defined by the prefix of the selected ledger identifier LIv (up to its entirety).

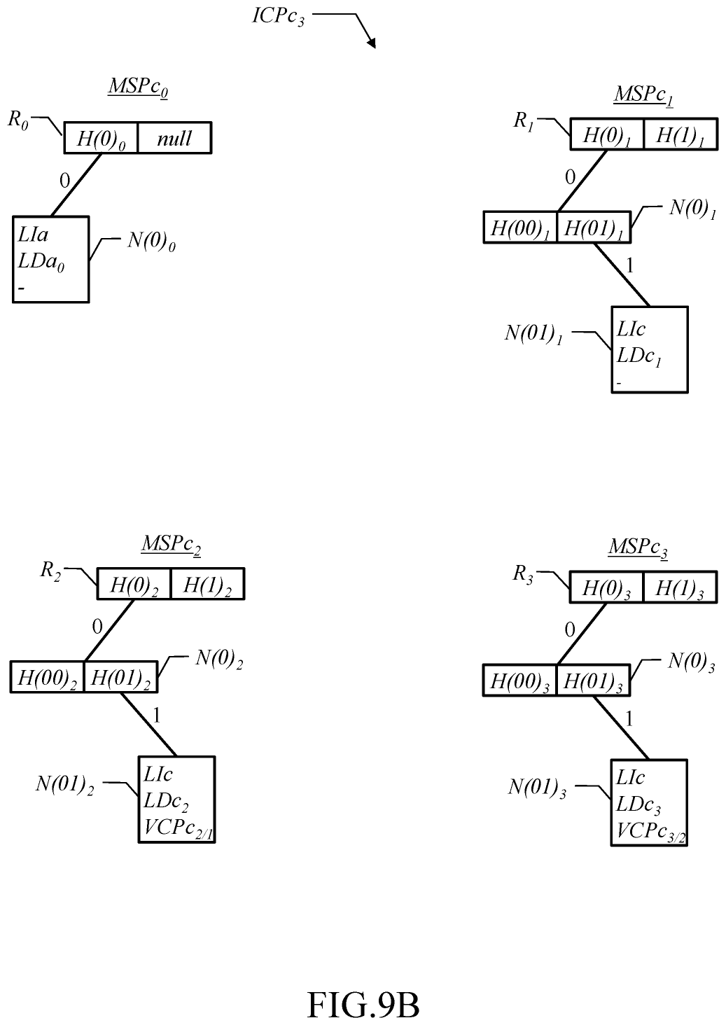

With reference to FIG. 9A-FIG. 9B, exemplary individual consistency proofs are shown that may be used to implement the solution according to an embodiment of the present disclosure. Starting from FIG. 9A, with reference to the dictionary versions DVₒ-DV₃ shown in FIG. 7A-FIG. 7B, the individual consistency proof ICPb₃ of the selected ledger identifier LIb=“10000000” and the selected ledger digest LDb₃ (ledger B) is defined by the membership proof MSPbₒ (tree path R₀) for the certification instant t₀, the membership proof MSPb₁ (tree path R and N(1)₁) for the certification instant t₁, the membership proof MSPb₂ (tree path R₂ and N(1)₂) for the certification instant t₂, and the membership proof MSPb₃ (tree path R₃, N(1)₃ and N(10)₃) for the certification instant t₃. Moving to FIG. 9B, with reference again to the dictionary versions DVₒ-DV₃ shown in FIG. 7A-FIG. 7B, the individual consistency proof ICPC₃ of the selected ledger identifier LIc=“01000000” and the selected ledger digest LDc₃ (ledger C) is defined by the membership proof MSPCₒ (tree path R₀ and N(0)₀) for the certification instant t₀, the membership proof MSPC₁ (tree path R₁, N(0)₁ and N(01)₁) for the certification instant t₁, the membership proof MSPc₂ (tree path R₂, N(0)₂ and N(01)₂) for the certification instant t₂, and the membership proof MSPC₃ (tree path R₃, N(0)₃ and N(01)₃) for the certification instant t₃.

A size of the individual consistency proof ICPvₛ depends linearly on the number(s) of the certification instants tᵢ. However, the size of the individual consistency proof ICPvₛ only depends logarithmically on the number (m) of the ledgers. In fact, the number of the leaf nodes (for the ledgers) increases exponentially with a depth of the search tree given by the number (d) of its level in case the search tree is balanced, as in the example at issue wherein the ledger identifiers LIj are progressive numbers when read in reverse order (m=2^{d}); therefore, the depth of the search tree (and then the length of the individual consistency proof ICPvₛ) increases logarithmically with the number of the ledgers (d=log₂(m)).

Returning to FIG. 6C, the exposing interface at block 634 returns the inclusion proof INPvₛ or the individual consistency proof ICPvₛ to the external client. The process then goes back to block 631 waiting for a next query. With reference again to the swim-lane of the external client, the verification agent at block 635 receives the inclusion proof INPvₛ or the individual consistency proof ICPvₛ from the certification node (being in a listening condition for it from block 630). The flow of activity then branches at block 636 according to the implementation of the solution according to an embodiment of the present disclosure. Particularly, in the basic implementation the blocks 637-643 are executed, in the comprehensive implementation based on the public storage the blocks 644-656 are executed, in the comprehensive implementation based on the monitors the blocks 657-665 are executed, and in the comprehensive implementation based on the individual consistency proof the blocks 666-682 are executed. In any case, the flow of activity then merges again at block 682.

With reference now to block 637 (basic implementation), the verification agent retrieves the verification information from the persistent storage, i.e., the ledger digests LDᵢ and the version consistency proofs VCP_{i/i-1} (for the certification instants tᵢ up to the selected certification instant tₛ, i=0 . . . s). A loop is entered at block 638 wherein the verification agent verifies the (current) version consistency proof VCP_{i/i-1} for a (current) certification instant tᵢ (starting from the one after the first certification instant to along the corresponding sequence, i=1 . . . s) according to the (current) ledger digest LDᵢ and the preceding ledger digest LDᵢ₋₁ (by using the version consistency proof VCP _{i/i-1} to calculate the ledger digests LDᵢ,LDᵢ₋₁ and then verifying that they match the corresponding expected values). The flow of activity branches at block 639 according to a result of this verification. If the version consistency proof VCP_{i/i-1} is satisfied, the verification agent at block 640 verifies whether a last version consistency proof VCP_{s/s-1} (for the selected certification instant tₛ) has been processed. If not, the flow of activity returns to block 638 to repeat the same operations for a next version consistency proof VCP_{i/i-1}. Conversely, once all the version consistency proofs VCP_{i/i-1} have been processed, the flow of activity branches at block 641 according to a comparison between the (calculated) value of the selected ledger digest LDₛ being calculated from the selected ledger version LVₛ and the (stored) value of the selected ledger digest LDₛ being stored in the persistent storage. If the calculated value and the stored value match, the verification agent at block 642 sets a result of the verification to positive. Conversely, the process passes to block 643 from block 639 (if the version consistency proof VCP_{i/i-1} is not satisfied) or from block 641 (if the calculated value and the stored value of the selected ledger digest LDₛ differ). In this case, the verification agent sets the result of the verification to negative. The process then continues to block 682 from block 642 or block 643.

With reference now to block 644 (comprehensive implementation based on the public storage), the verification agent retrieves the verification information from the persistent storage, i.e., the dictionary digests DDᵢ (for the certification instants tᵢ up to the selected certification instant tₛ, i=0 . . . s). Moreover, the verification agent at block 645 retrieves the dictionary versions DVᵢ (for the same certification instants tᵢ, i=0 . . . s) from the public storage. A loop is entered at block 646, wherein the verification agent takes a (current) dictionary version DVᵢ for a (current) certification instant tᵢ into account (starting from the first one along the corresponding sequence). First of all, the verification agent calculates the (current) dictionary digest DDᵢ of the dictionary version DVᵢ as above. The flow of activity branches at block 647 according to a comparison between the (calculated) value of the dictionary digest DDᵢ being calculated and the (stored) value of the dictionary digest DDᵢ being stored in the persistent storage. If the calculated value and the stored value match (confirming integrity of the dictionary version DVᵢ), the flow of activity branches at block 648 according to a status of the selected ledger identifier LIv in the dictionary version DVᵢ. If the selected ledger identifier LIv is excluded from the dictionary version DVᵢ block 649 is executed, whereas if the selected ledger identifier LIv is included in the dictionary version DVᵢ blocks 650-652 are executed; in both cases, the flow of activity merges again at block 653. With reference now to block 649 (excluded), the flow of activity further branches according to a status of the selected ledger identifier LIv in the preceding dictionary version DVᵢ₋₁, if any. If the selected ledger identifier LIv is excluded from the preceding dictionary version DVᵢ₋₁ as well (always true for the first certification instant t₀) the process descends into block 653. With reference instead to block 650 (included), the flow of activity again branches according to the status of the selected ledger identifier LIv in the preceding dictionary version DVᵢ₋₁, if any. If the selected ledger identifier LIv is included in the preceding dictionary version DVᵢ₋₁ as well, the verification agent at block 651 verifies the version consistency proof VCPv_{i/i-1} according to the corresponding ledger digests LDvᵢ,LDVᵢ₋₁ (for the dictionary versions DVᵢ,DVᵢ₋₁), by using the version consistency proof VCPv_{i/i-1} to calculate the ledger digests LDvᵢ,LDVᵢ₋₁ and then verifying that they match the corresponding expected values. The flow of activity branches at block 652 according to a result of this verification. If the version consistency proof VCPv_{i/i-1} is satisfied, the process descends into block 653; the same point is also reached directly from block 650 if the selected ledger identifier LIv is excluded from the preceding dictionary version DVᵢ₋₁ (always true for the first certification instant t₀). With reference now to block 653, the verification agent verifies whether the last dictionary version DVₛ (for the selected certification instant tₛ) has been processed. If not, the flow of activity returns to block 645 to repeat the same operations for a next dictionary version DVᵢ. Conversely, once all the dictionary versions DVᵢ have been processed, the flow of activity branches at block 654 according to a comparison between the (calculated) value of the selected ledger digest LDvₛ being calculated from the selected ledger version LVvₛ and the (stored) value of the selected ledger digest LDvₛ being stored in the persistent storage. If the calculated value and the stored value match, the verification agent at block 655 sets a result of the verification to positive. Conversely, the process passes to block 656 from block 647 (if the calculated value and the stored value of the dictionary digest DDᵢ differ), from block 649 (if the selected ledger identifier LIv is included in the preceding dictionary version DVᵢ₋₁ and excluded from the dictionary version DVᵢ), from block 652 (if the version consistency proof VCPv_{i/i-1} is not satisfied) or from block 654 (if the calculated value and the stored value of the selected ledger digest LDvₛ differ). In this case, the verification agent sets the result of the verification to negative. The process then continues to block 682 from block 655 or block 656.

With reference now to block 657 (comprehensive implementation based on the monitors), the verification agent queries a (trusted) monitoring server, or more, for receiving the global consistency indicators GCIᵢ (for the certification instants tᵢ up to the selected certification instant tₛ, i=0 . . . s); alternatively, the monitoring manager may returns a (single) summarizing consistency indicator that is asserted when all these global consistency indicators GCIᵢ are asserted or it is deasserted otherwise. The flow of activity branches at block 658 according to the global consistency indicators GCIᵢ. Particularly, if all the global consistency indicators GCIᵢ are asserted (or the summarizing consistency indicator is asserted), the verification agent verifies the inclusion proof INPvₛ. In the example at issue, the following operations are performed for this purpose. The verification agent at block 659 calculates the dictionary digest DDs of the dictionary version DVₛ as the hash value of the concatenation of the hash value of the first (root) node of the inclusion proof INPvₛ with of the preceding dictionary digest DDₛ₋₁, if any; the verification agent then verifies that the (calculated) value of the dictionary digest DDₛ being calculated matches the (stored) value of the dictionary digest DDₛ being stored in the persistent storage. With reference again to FIG. 8, in case of the inclusion proof INPa₃ the verification agent calculates the hash value of the concatenation of the hash value of the root node R₃ with the dictionary digest DD₂, and then verifies that it matches the dictionary digest DD₃. The verification agent at block 660 verifies that the search path of the inclusion proof INPvₛ defines the prefix of the selected ledger identifier LIv (up to its entirety). With reference again to FIG. 8, in case of the inclusion proof INPa₃ the verification agent verifies that the ledger identifier LIa=“00000000” begins with the search key “000”. The verification agent at block 661 verifies that each internal node of the inclusion proof INPvₛ is not a leaf node and its (left or right) field along the search path of the selected ledger identifier LIv contains the hash value of the next (child) node of the inclusion proof INPvₛ. With reference again to FIG. 8, in case of the inclusion proof INPa₃ the verification agent verifies that the left field of the root node R₃ contains the hash value H(0)₃ of the node N(0)₃, the left field of the node N(0)₃ contains the hash value H(00)₃ of the node N(00)₃, and the left field of the node N(00)₃ contains the hash value H(000)₃. The verification agent at block 662 verifies that the last node of the inclusion proof INPvₛ is a leaf node and contains the selected ledger identifier LIv and the selected ledger digest LDvₛ. With reference again to FIG. 8, in case of the inclusion proof INPa₃ the verification agent verifies that the node N(000)₃ is a leaf node containing the ledger identifier LIa=“00000000” and the ledger digest LDa₃. The flow of activity branches at block 663 according to a result of the above-mentioned operations. If all the conditions are satisfied, it is possible to conclude that the selected ledger identifier LIv and the selected ledger digest LDvₛ are included in the dictionary version DVₛ for the selected certification instant tₛ. In this case, the verification agent at block 664 sets a result of the verification to positive. Conversely, the process passes to block 665 from block 658 (if one or more global consistency indicators GCIᵢ, or the summarizing consistency indicator, are deasserted) or from block 663 (if one or more conditions of the inclusion proof INPvₛ are not satisfied). In this case, the verification agent sets the result of the verification to negative. The process then continues to block 682 from block 664 or block 665.

With reference now to block 666 (comprehensive implementation based on the individual consistency proof), the verification agent retrieves the verification information from the persistent storage, i.e., the dictionary digests DDᵢ (for the certification instants tᵢ up to the selected certification instant tₛ, i=0 . . . s). The verification agent then verifies the individual consistency proof ICPvₛ; in the example at issue, the following operations are performed for this purpose. Particularly, a loop is entered at block 667 wherein the verification agent takes a (current) membership proof MSPvᵢ of the individual consistency proof ICPvₛ for a (current) certification instant tᵢ into account (starting from the first one along the corresponding sequence). The verification agent then verifies the membership proof MSPvᵢ as above (apart for its last node). Particularly, the verification agent at block 668 calculates the dictionary digest DDᵢ of the dictionary version DVᵢ for the certification instant tᵢ as the hash value of the concatenation of the hash value of the first (root) node of the membership proof MSPvᵢ with the preceding dictionary digest DDᵢ₋₁, if any; the verification agent then verifies that the (calculated) value of the dictionary digest DDᵢ being calculated matches the (stored) value of the dictionary digest DDᵢ being stored in the persistent storage. The verification agent at block 669 verifies that the search path of the membership proof MSPvᵢ defines the prefix of the selected ledger identifier LIv (up to its entirety). The verification agent at block 670 verifies that each internal node of the membership proof MSPvᵢ is not a leaf node and its (left or right) field along the search path of the selected ledger identifier LIv contains the hash value of the next (child) node of the membership proof MSPvᵢ. In this case, instead, the verification agent at block 671 verifies that if the last node is an internal node it has the (left or right) field along the search path defined by the selected ledger identifier LIv containing the null value. The flow of activity branches at block 672 according to a result of the above-mentioned operations. If all the conditions are satisfied, the verification agent at block 673 determines a type of the membership proof MSPvᵢ (exclusion or inclusion). Particularly, if the last node is a leaf node that does not contain the selected ledger identifier LIv or it is an internal node that has the (left or right) field along the search path defined by the selected ledger identifier LIv containing the null value, this means that the selected ledger identifier LIv is excluded from the dictionary version DVᵢ (exclusion proof satisfied). Conversely, if the last node is a leaf node and it contains the selected ledger identifier LIv, this means that the selected ledger identifier LIv is included in the dictionary version DVᵢ (inclusion proof satisfied). The flow of activity then branches at block 674 according to the above-mentioned verification. If the selected ledger identifier LIv is excluded from the dictionary version DVᵢ block 675 is executed, whereas if the selected ledger identifier LIv is included in the dictionary version DVᵢ blocks 676-678 are executed; in both cases, the flow of activity merges again at block 679. With reference now to block 675 (excluded), the flow of activity further branches according to the verification of the (preceding) membership proof MSPvᵢ₋₁ for the preceding certification instant tᵢ₋₁, if any. If the preceding membership proof MSPvᵢ₋₁ has satisfied the exclusion proof as well (always true for the first certification instant t₀) the process descends into block 679. With reference instead to block 676 (included), the flow of activity again branches according to the verification of the preceding membership proof MSPvᵢ₋₁, if any. If the preceding membership proof MSPvᵢ₋₁ has satisfied the inclusion proof as well, the verification agent at block 677 verifies that the last node contains the corresponding version consistency proof VCPv_{i/i-1} and that it is satisfied according to the ledger digests LDvᵢ,LDVᵢ₋₁ as indicated in the membership proofs MSPvᵢ,MSPvᵢ₋₁ (by using the version consistency proof VCPV_{i/i-1} to calculate the ledger digests LDvᵢ,LDvᵢ₋₁ and then verifying that they match the corresponding expected values). The flow of activity branches at block 678 according to a result of this verification. If the version consistency proof VCPv_{i/i-1} is satisfied, the process descends into block 679; the same point is also reached directly from block 676 if the preceding membership proof MSPvᵢ₋₁ has satisfied the exclusion proof (always true for the first certification instant t₀).

With reference again to FIG. 9A, in case of the individual consistency proof ICPb₃, for the certification instant t₀ the verification agent verifies that the last node R₀ is an internal node that has the right field along the search path defined by the ledger identifier LIb (“1”) containing the null value (excluded), for the certification instant t₁ the verification agent verifies that the last node N(1)₁ is a leaf node that contains the ledger identifier LIb (included), for the certification instant t₂ the verification agent verifies that the last node N(1)₂ is a leaf node that contains the ledger identifier LIb (included), and for the certification instant t₃ the verification agent verifies that the last node N(10)₃ is a leaf node that contains the ledger identifier Lib (included). With reference instead to FIG. 9B, in case of the individual consistency proof ICPC₃, for the certification instant t₀ the verification agent verifies that the last node N(0)₀ is a leaf node that does not contain the ledger identifier LIc (excluded), for the certification instant tᵢ the verification agent verifies that the last node N(01)₁ is a leaf node that contains the ledger identifier LIc (included), for the certification instant t₂ the verification agent verifies that the last node N(01)₂ is a leaf node that contains the ledger identifier LIc (included), and for the certification instant t₃ the verification agent verifies that the last node N(01)₃ is a leaf node that contains the ledger identifier LIc (included).

Returning to FIG. 6G, the verification agent at block 679 verifies whether a last membership proof MSPvₛ (for the selected certification instant tₛ) has been processed. If not, the flow of activity returns to block 667 to repeat the same operations for a next membership proof MSPvᵢ. Conversely, once all the membership proofs MSPvᵢ have been processed, the flow of activity branches at block 680 according to the verification of the last node of the last membership proof MSPvₛ. If the last membership proof MSPvₛ has satisfied the inclusion proof, it is possible to conclude that the selected ledger has been created and that afterwards it always exists, and that each pair of consecutive versions of the selected ledger are consistent (up to the selected ledger version). In this case, the flow of activity branches at block 681 according to a comparison between the (calculated) value of the selected ledger digest LDvₛ being calculated from the selected ledger version LVvₛ and the (provided) value of the selected ledger digest LDvₛ in the last node of the last membership proof MSPvₛ. If the calculated value and the provided value match, the verification agent at block 681 sets a result of the verification to positive. Conversely, the process passes to block 682 from block 672 (if one or more of the conditions of the membership proof MSPvᵢ are not satisfied), from block 675 (if the preceding membership proof MSPvᵢ₋₁ has satisfied the inclusion proof and the membership proof MSPvᵢ has satisfied the exclusion proof), from block 678 (if the version consistency proof VCPv_{i/i-1} is not satisfied) or from block 680 (if the calculated value and the provided value of the selected ledger digest LDvₛ differ). In this case, the verification agent sets the result of the verification to negative. The process then continues to block 682 from block 681 or block 682.

With reference now to block 683, the flow of activity branches according to a result of the above-described verification. If the result of the verification is positive, the verification agent at block 684 accepts the selected ledger version LVvₛ for its intended use (or confirms that the selected ledger with the selected ledger digest LDvₛ has a single consistent history). Conversely, if the result of the verification is negative, the verification agent at block 685 refuses the selected ledger version LVvₛ (or does not confirm that the selected ledger with the selected ledger digest LDvₛ has a single consistent history), for example, by entering an error condition with a corresponding warning that is provided to the corresponding external subject, such as displayed on the monitor of the external client. In both cases, the process returns from block 684 or from block 685 to block 627 waiting for the verification of a next ledger version.

### Modifications

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may be practiced even without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for certifying data. However, the data may be of any type (for example, partial, different and additional data with respect to the ones mentioned above) and they may be certified for any purpose (for example, for consumers, auditors, public authorities and so on).

In an embodiment, the data are stored in one or more ledgers produced in a private environment. However, the ledgers may be in any number and of any type (for example, private distributed ledgers (DLTs), blockchains, logs or any other data structures configured to append data to an end thereof) and produced in any private environment (for example, a company, an organization, a consortium and so on).

In an embodiment, the method comprises the following steps under the control of a certification computing system being internal to the private environment. However, the certification computing system may be of any type (see below).

In an embodiment, the method comprises accessing (by the certification computing system) corresponding ledger versions of each of the ledgers being generated by appending corresponding data thereto, the ledger versions being accessed for a sequence of certification instants. However, the ledger versions may be accessed in any way (for example, by taking a snapshot of the ledgers, either globally or individually, when the ledger are quiescent with no data that may be appended thereto, such as at night, and so on) at any certification instants (for example, periodically, whenever the amount of data appended to any ledger or overall reaches a threshold, and so on).

In an embodiment, the method comprises calculating (by the certification computing system) corresponding ledger digests based on all the data of the ledger versions of each ledger for the certification instants. However, each ledger digest may be calculated in any way (for example, defined by the Merkle tree root of the data blocks, by the hash value of a concatenation of the hash values of the data blocks, by the hash value of its entire content and so on) according to the corresponding ledger version (for example, based on its data and ledger identifier, on its data only and so on).

In an embodiment, the method comprises calculating (by the certification computing system) corresponding version consistency proofs of each ledger for one or more of the certification instants following a creation certification instant of the certification instants corresponding to a creation of the ledger, wherein each of the version consistency proofs of the ledger is for verifying that the ledger version of the ledger for the corresponding certification instant is consistent with respect to the ledger version of the ledger for a preceding one of the certification instants immediately preceding the certification instant along the sequence (meaning that the ledger version for the certification instant contains the ledger version for the preceding certification instant without alteration and that the ledger version for the certification instant has been obtained by extending the ledger version for the preceding certification instant) according to the corresponding ledger digests without knowledge of the corresponding versions of the ledger. However, each version consistency proof may be of any type (for example, the Merkle consistency proof, the hash values of all the data blocks of the corresponding ledger versions and so on).

In an embodiment, the method comprises exposing (by the certification computing system) verification information outside the private environment comprising storing at least part of the verification information for verifying integrity thereof into a persistent storage of persistent type being external to the private environment. However, the persistent storage may be of any type (for example, a distributed ledger, such as a public blockchain, a centralized ledger, such as a log guaranteed by a trusted authority, and so on); the verification information stored in the persistent storage may be of any type (for example, the ledger digests with or without the corresponding version consistency proofs, the dictionary digests, the dictionary versions and so on), with the rest of the verification information, if any, that may be exposed outside the private environment in any way (for example, published, returned in response to corresponding queries and so on).

In an embodiment, the verification information is based on the ledger digests and the version consistency proofs for allowing one or more external computing systems being external to the private environment to verify that each selected ledger of the ledgers to be verified has a single consistent history (meaning that each of the ledger versions of the selected ledger up to a selected one of the ledger versions of the selected ledger corresponding to a selected one of the certification instants along the sequence contains a preceding one of the ledger versions of the selected ledger for the certification instant immediately preceding the certification instant of the ledger version without alteration and that the ledger version has been obtained by extending the preceding ledger version) without knowledge of the corresponding ledger versions of the selected ledger. However, the external computing systems may be in any number and of any type (see below); moreover, the verification information may be of any type (for example, the ledger digests with the corresponding version consistency proofs, the dictionary digests with the global consistency proofs, the dictionary digests with the dictionary versions, the dictionary digests with each inclusions proof, the dictionary digests with each individual consistency proof and so on).

Further embodiments provide additional advantageous features, which may however be omitted at all in a basic implementation.

In an embodiment, the ledgers are a plurality of ledgers identified by corresponding ledger identifiers. However, the ledger identifiers may be of any type (for example, consecutive numbers, public keys, random numbers and so on).

In an embodiment, the method comprises building (by the certification computing system) corresponding dictionary versions of a dictionary for the certification instants, wherein each of the dictionary versions comprises corresponding records for one or more of the ledgers (having been created before the corresponding certification instant) each associated with the ledger identifier of the corresponding ledger and comprising the ledger digest of the corresponding ledger and the possible version consistency proof of the corresponding ledger for the corresponding certification instant. However, the dictionary may be of any type (for example, with the records organized in a tree, a list and so on) and each record may be associated with the corresponding ledger identifier in any way (for example, used as access key, included in the record and so on).

In an embodiment, the method comprises exposing (by the certification computing system) the verification information outside the private environment comprising storing information for verifying integrity of the dictionary versions into the persistent storage. However, the information stored in the persistent storage may be of any type (for example, the dictionary digests, the dictionary versions and so on).

In an embodiment, the verification information is based on the dictionary versions for allowing the external computing systems to verify that a selected one of the ledger identifiers of the selected ledger is excluded from the dictionary versions for any of the certification instants preceding the creation instant thereof along the sequence, that the selected ledger identifier is included in the dictionary versions for each of the certification instants starting from the creation instant of the selected ledger up to the selected certification instant along the sequence with the dictionary version for the selected certification instant containing a selected one of the ledger digests of the selected ledger version, and that the corresponding version consistency proofs are satisfied. However, in this case the verification information may be of any type (for example, the dictionary digests with the global consistency proofs, the dictionary digests with the dictionary versions, the dictionary digests with each inclusions proof, the dictionary digests with each individual consistency proof and so on).

In an embodiment, the method comprises calculating (by the certification computing system) the ledger digests of each of the ledgers based on the ledger identifier and the corresponding ledger versions of the ledger. However, this result may be achieved in different ways (for example, by including the ledger identifier in the genesis block of the ledger, by concatenating the content of the ledger and its ledger identifier and so on).

In an embodiment, the method comprises calculating (by the certification computing system) corresponding dictionary digests based on the dictionary versions for the certification instants. However, each dictionary digest may be calculated in any way (for example, based on the corresponding dictionary version and the preceding dictionary digest, only on the corresponding dictionary version, by taking into account for the dictionary version its root node only, its entire content and so on).

In an embodiment, the method comprises exposing (by the certification computing system) the verification information outside the private environment comprising storing the dictionary digests into the persistent storage. However, the dictionary digests may be stored into the persistent storage alone or in combination with any other piece of the verification information (for example, the global consistency proofs, the dictionary versions and so on).

In an embodiment, the method comprises exposing (by the certification computing system) the verification information outside the private environment comprising publishing the dictionary versions into a public storage. However, the public storage may be of any type (for example, a cloud storage, a web site and so on) and the dictionary versions may be used for any purpose (for example, directly by the external computing systems to verify the selected ledger, by monitoring computing systems performing this operation on behalf of the external computing systems and so on).

In an embodiment, the dictionary versions being published are for allowing the external computing systems to verify that if the selected ledger identifier is included in any of the dictionary versions (for a corresponding one of the certification instants preceding the selected certification instant along the sequence) the selected ledger identifier is included in the dictionary version for the certification instant following the certification instant, that the corresponding version consistency proof is satisfied and that the selected ledger version is included in the dictionary version for the selected certification instant. However, the dictionary versions may be used for this purpose in any way (for example, by verifying the consistency individually for the selected ledger only, globally for all the ledgers and so on).

In an embodiment, the dictionary versions being published are for allowing one or more monitoring computing systems (being external to the private environment) to determine corresponding global consistency indicators for the certification instants, the global consistency indicator for each of the certification instants being determined by verifying that all the ledger identifiers that are included in each of the dictionary versions (for a corresponding one of the certification instants preceding the selected certification instant along the sequence) are included in the dictionary version for the certification instant following the certification instant and that the corresponding version consistency proofs are satisfied. However, the monitoring computing systems may be in any number and of any type (see below) and the dictionary versions may be used by them in different ways (for example, by verifying the consistency globally for all the ledgers, individually for the selected ledger only upon request and so on).

In an embodiment, the dictionary versions being published are for allowing the monitoring computing systems to return an indication of the global consistency indicators for the certification instants up to the selected certification instant along the sequence in response to a corresponding query from each of the external computing systems. However, this information may be returned in any way (for example, by returning all the corresponding global consistency indicators, the summarizing consistency indicator based thereon and so on).

In an embodiment, the method comprises calculating (by the certification computing system) an inclusion proof of the selected ledger identifier and the selected ledger digest, wherein the inclusion proof is for verifying that the selected ledger identifier and the selected ledger digest are included in the dictionary version for the selected certification instant according to the dictionary digests. However, the inclusion proof may be of any type (for example, the corresponding nodes of the search tree of the dictionary version corresponding to the selected certification instant, the whole dictionary version corresponding to the selected certification instant and so on).

In an embodiment, the method comprises exposing (by the certification computing system) the verification information outside the private environment comprising the inclusion proof. However, the inclusion proof may be exposed in any way (for example, returned in response to a verification request of the selected ledger, stored in the persistent storage or published for each ledger of each dictionary version and so on).

In an embodiment, the method comprises calculating (by the certification computing system) an individual consistency proof of the selected ledger identifier and the selected ledger digest, wherein the individual consistency proof is for verifying that if the selected ledger identifier is included in each of the dictionary versions (for a corresponding one of the certification instants preceding the selected certification instant along the sequence) the selected ledger identifier is included in the dictionary version for the certification instant following the corresponding certification instant, that the corresponding version consistency proof is satisfied and that the selected ledger digest is included in the dictionary version for the selected certification instant according to the dictionary digests. However, the individual consistency proof may be of any type (for example, defined by the corresponding membership proofs, by the whole corresponding dictionary versions and so on). Moreover, the possibility is not excluded of having the individual consistency proof built by any corresponding producer node, any external client having access to the dictionary versions and so on.

In an embodiment, the method comprises exposing (by the certification computing system), the verification information outside the private environment comprising the individual consistency proof. However, the individual consistency proof may be exposed in any way (for example, returned in response to a verification request of the selected ledger, stored in the persistent storage or published for each ledger of each dictionary version and so on).

In an embodiment, the method comprises building (by the certification computing system) the dictionary version for each of the certification instants comprising a search tree having a plurality of nodes comprising one or more leaf nodes of the nodes for the corresponding ledgers being identified by corresponding search keys based on the ledger identifiers of the corresponding ledgers (each of the leaf nodes containing the ledger identifier of the corresponding ledger, the ledger digest of the corresponding ledger for the corresponding certification instant and the possible corresponding version consistency proof) and one or more internal nodes of the nodes (each of the internal nodes having a plurality of corresponding fields for possible child nodes of the nodes descending therefrom each containing a hash value of the corresponding child node or a null value otherwise). However, the search tree may be of any type (for example, a binary tree or a general tree wherein each internal node may have any number of child nodes, with the fields without child nodes that may contain any null value, and so on).

In an embodiment, the method comprises calculating (by the certification computing system) the dictionary digest for each of the certification instants based on a root node of the nodes of the dictionary version for the corresponding certification instant and the dictionary digest for the possible certification instant preceding the corresponding certification instant along the sequence. However, the possibility is not excluded of calculating each dictionary digest in different ways (for example, as the hash value of the concatenation of the preceding dictionary digest with the whole corresponding dictionary version, with the Merkle tree root of its nodes and so on), even independently of the preceding dictionary digest.

In an embodiment, the method comprises calculating (by the certification computing system) the inclusion proof comprising a tree path of the dictionary version for the selected certification instant defined by the corresponding nodes along a search path of the selected ledger based on the selected ledger identifier. This allows the external computing systems to verify the selected ledger by performing the following operations. The selected ledger is verified by calculating the dictionary digest for the selected certification instant from a first one of the nodes of the inclusion proof and the dictionary digest for the certification instant preceding the selected certification instant if different from the first certification instant, and verifying that the dictionary digest being calculated matches the dictionary digest for the selected certification instant being stored in the persistent storage. The selected ledger is verified by verifying that the search key of a last one of the nodes of the inclusion proof is comprised in the search path of the selected ledger. The selected ledger is verified by verifying that each of the nodes of the inclusion proof different from the last node is an internal node and has the field corresponding to the search path of the selected ledger containing the hash value of a next one of the nodes of the inclusion proof. The selected ledger is verified by verifying that the last node is a leaf node containing the selected ledger identifier and the selected ledger digest. However, the possibility is not excluded of defining (and then verifying) the inclusion proof in different ways (according to the definition of the dictionary).

In an embodiment, the method comprises calculating (by the certification computing system) the individual consistency proof comprising corresponding membership proofs for the certification instants up to the selected certification instant along the sequence, wherein each of the membership proofs comprises a tree path of the dictionary version for the corresponding certification instant defined by the corresponding nodes along a search path of the selected ledger based on the selected ledger identifier. This allows the external computing systems to verify the selected ledger comprising verifying each of the membership proofs by performing the following operations. The membership proof is verified by calculating the dictionary digest for the corresponding certification instant from a first one of the nodes of the membership proof and the dictionary digest for the certification instant preceding the corresponding certification instant if different from the first certification instant, and verifying that the dictionary digest being calculated matches the dictionary digest for the corresponding certification instant being stored in the persistent storage. The membership proof is verified by verifying that the search key of a last one of the nodes of the membership proof is comprised in the search path of the selected ledger. The membership proof is verified by verifying that each of the nodes of the membership proof different from the last node is an internal node and has the field corresponding to the search path of the selected ledger containing the hash value of a next one of the nodes of the membership proof. The membership proof is verified by verifying that if the last node is an internal node the last node has the field along the search path of the selected ledger containing the null value. The membership proof is verified by verifying that the selected ledger identifier is excluded from the dictionary version for the corresponding certification instant in response to the last node being a leaf node not containing the selected ledger identifier or an internal node having the field along the search path of the selected ledger containing the null value, or that the selected ledger identifier is included in the dictionary version for the corresponding certification instant in response to the last node being a leaf node containing the selected ledger identifier. The membership proof is verified by verifying that the selected ledger identifier is excluded from the dictionary version for the possible certification instant preceding the corresponding certification instant if the selected ledger identifier is excluded from the dictionary version for the corresponding certification instant or verifying that the version consistency proof of the last node is satisfied if the selected ledger identifier is included in the dictionary versions for the corresponding certification instant and for the possible certification instant preceding the corresponding certification instant. The verification of the selected ledger further comprises verifying that the selected ledger identifier and the selected ledger digest are included in the membership proof for the selected certification instant. However, the possibility is not excluded of defining (and then verifying) the individual consistency proof in different ways (according to the definition of the dictionary).

In an embodiment, the ledgers are a single ledger and the method comprises exposing (by the certification computing system) the verification information outside the private environment comprising the ledger digests and the version consistency proofs with at least the ledger digests being stored into the persistent storage. However, the verification information may be exposed in any way (for example, by storing it entirely into the persistent storage, by storing the ledger digests only into the persistent storage with the version consistency proofs that are published or returned upon request, and so on).

Generally, similar considerations apply if the same solution is implemented with an equivalent method (by using similar steps with the same functions of more steps or portions thereof, removing some non-essential steps or adding further optional steps); moreover, the steps may be performed in a different order, concurrently or in an interleaved way (at least in part).

An embodiment provides a computer program configured for causing a certification computing system to perform the method of above when the computer program is executed on the certification computing system. An embodiment provides a computer program product, the computer program product comprising one or more computer readable storage media having program instructions collectively stored on the readable storage media, the program instructions readable by a certification computing system to cause the certification computing system to perform the same method.

Generally, the (software) program may be implemented as a stand-alone module, as a plug-in for a pre-existing software program (for example, an administration manager of the certification computing system for managing the participation to the ledgers) or even directly in the latter. It would be readily apparent that it is also possible to deploy the same solution as a service that is accessed through a network (such as in the Internet). Similar consideration apply if the program is structured in a different way, or if additional modules or functions are provided; likewise, the memory structures may be of other types, or may be replaced with equivalent entities (not necessarily consisting of physical storage media). The program may take any form suitable to be used by any (certification/storage) computing system (see below), thereby configuring the computing system to perform the desired operations; particularly, the program may be in the form of external or resident software, firmware, or microcode (either in object code or in source code), for example, to be compiled or interpreted. Moreover, it is possible to provide the program on any computer readable storage medium. The storage medium is any tangible medium (different from transitory signals per se) that may retain and store instructions for use by the computing system. For example, the storage medium may be of the electronic, magnetic, optical, electromagnetic, infrared, or semiconductor type; examples of such storage medium are fixed disks (where the program may be pre-loaded), removable disks, memory keys (for example, USB), and the like. The program may be downloaded to the computing system from the storage medium or via a network (for example, the Internet, a wide area network and/or a local area network comprising transmission cables, optical fibers, wireless connections, network devices); one or more network adapters in the computing system receive the program from the network and forward it for storage into one or more storage devices of the computing system. In any case, the solution according to an embodiment of the present disclosure lends itself to be implemented even with a hardware structure (for example, by electronic circuits integrated on one or more chips of semiconductor material), or with a combination of software and hardware suitably programmed or otherwise configured.

An embodiment provides a certification computing system comprising means configured for performing the steps of the method of above. An embodiment provides a certification computing system comprising a circuitry (i.e., any hardware suitably configured, for example, by software) for performing each step of the same method. However, the certification computing system may be of any type (for example, implemented by a physical server, a virtual machine, a cloud service and so on).

An embodiment provides an information technology infrastructure for certifying data comprising the certification computing system and one or more external computing systems comprising means (or circuitry) for performing the corresponding operations. In an embodiment, the information technology infrastructure further comprises one or more monitoring computing systems comprising means (or circuitry) for performing the corresponding operations. However, the external computing systems and the monitoring computing systems may be in any number and of any type (for example, personal computers, tablets, smartphones and so on for the external computing systems and physical servers, virtual machines, cloud services and so on for the monitoring computing systems); the information technology infrastructure may have a different architecture (for example, based on a global, local or wide area network, exploiting any type of wired and/or wireless connections, such as of metal wire, optical fiber, Wi-fi, mobile telephone or satellite type, implemented by virtual machines running on a same physical machine, and so on).

Generally, similar considerations apply if the certification computing system, the external computing systems, the monitoring computing systems and the information technology infrastructure each has a different structure, comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

1. A method for certifying data stored in one or more ledgers produced in a private environment, wherein the method comprises, under the control of a certification computing system being internal to the private environment:
accessing, by the certification computing system, corresponding ledger versions of each of the ledgers being generated by appending corresponding data thereto, the ledger versions being accessed for a sequence of certification instants,
calculating, by the certification computing system, corresponding ledger digests based on all the data of the ledger versions of each ledger for the certification instants,
calculating, by the certification computing system, corresponding version consistency proofs of each ledger for one or more of the certification instants following a creation certification instant of the certification instants corresponding to a creation of the ledger, each of the version consistency proofs of the ledger being for verifying that the ledger version of the ledger for the corresponding certification instant is consistent with respect to the ledger version of the ledger for a preceding one of the certification instants immediately preceding the certification instant along the sequence, meaning that the ledger version for the certification instant contains the ledger version for the preceding certification instant without alteration and that the ledger version for the certification instant has been obtained by extending the ledger version for the preceding certification instant, according to the corresponding ledger digests without knowledge of the corresponding versions of the ledger, and
exposing, by the certification computing system, verification information outside the private environment comprising storing at least part of the verification information for verifying integrity thereof into a persistent storage of persistent type being external to the private environment, the verification information being based on the ledger digests and the version consistency proofs for allowing one or more external computing systems being external to the private environment to verify that each selected ledger of the ledgers to be verified has a single consistent history, meaning that each of the ledger versions of the selected ledger up to a selected one of the ledger versions of the selected ledger corresponding to a selected one of the certification instants along the sequence contains a preceding one of the ledger versions of the selected ledger for the certification instant immediately preceding the certification instant of the ledger version without alteration and that the ledger version has been obtained by extending the preceding ledger version, without knowledge of the corresponding ledger versions of the selected ledger.

2. The method according to claim 1, wherein the ledgers are a plurality of ledgers identified by corresponding ledger identifiers, the method comprising:
building, by the certification computing system, corresponding dictionary versions of a dictionary for the certification instants, each of the dictionary versions comprising corresponding records for one or more of the ledgers having been created before the corresponding certification instant each associated with the ledger identifier of the corresponding ledger and comprising the ledger digest of the corresponding ledger and the possible version consistency proof of the corresponding ledger for the corresponding certification instant, and
exposing, by the certification computing system, the verification information outside the private environment comprising storing information for verifying integrity of the dictionary versions into the persistent storage, the verification information being based on the dictionary versions for allowing the external computing systems to verify that a selected one of the ledger identifiers of the selected ledger is excluded from the dictionary versions for any of the certification instants preceding the creation instant thereof along the sequence, that the selected ledger identifier is included in the dictionary versions for each of the certification instants starting from the creation instant of the selected ledger up to the selected certification instant along the sequence with the dictionary version for the selected certification instant containing a selected one of the ledger digests of the selected ledger version, and that the corresponding version consistency proofs VGA are satisfied.

3. The method according to claim, wherein the method comprises:
calculating, by the certification computing system, the ledger digests of each of the ledgers based on the ledger identifier and the corresponding ledger versions of the ledger.

4. The method according to claim 2, wherein the method comprises:
calculating, by the certification computing system, corresponding dictionary digests based on the dictionary versions for the certification instants, and
exposing, by the certification computing system, the verification information outside the private environment comprising storing the dictionary digests into the persistent storage.

5. The method according to claim 4, wherein the method comprises:
exposing, by the certification computing system, the verification information outside the private environment comprising publishing the dictionary versions into a public storage.

6. The method according to claim 5, wherein the method comprises:
publishing, by the certification computing system, the dictionary versions into the public storage for allowing the external computing systems to verify that if the selected ledger identifier is included in any of the dictionary versions, for a corresponding one of the certification instants preceding the selected certification instant along the sequence, the selected ledger identifier is included in the dictionary version for the certification instant following the certification instant, that the corresponding version consistency proof is satisfied and that the selected ledger version is included in the dictionary version for the selected certification instant.

7. The method according to claim 5, wherein the method comprises:
publishing, by the certification computing system, the dictionary versions into the public storage for allowing one or more monitoring computing systems being external to the private environment to:
determine corresponding global consistency indicators for the certification instants, the global consistency indicator for each of the certification instants being determined by verifying that all the ledger identifiers that are included in each of the dictionary versions, for a corresponding one of the certification instants preceding the selected certification instant along the sequence, are included in the dictionary version for the certification instant following the certification instant and that the corresponding version consistency proofs are satisfied, and
return an indication of the global consistency indicators for the certification instants up to the selected certification instant along the sequence in response to a corresponding query from each of the external computing systems.

8. The method according to claim 5, wherein the method comprises:
calculating, by the certification computing system, an inclusion proof of the selected ledger identifier and the selected ledger digest, the inclusion proof being for verifying that the selected ledger identifier and the selected ledger digest are included in the dictionary version for the selected certification instant according to the dictionary digests, and
exposing, by the certification computing system, the verification information outside the private environment comprising the inclusion proof.

9. The method according to claim 4, wherein the method comprises:
calculating, by the certification computing system, an individual consistency proof of the selected ledger identifier and the selected ledger digest, the individual consistency proof being for verifying that if the selected ledger identifier is included in any of the dictionary versions, for a corresponding one of the certification instants preceding the selected certification instant along the sequence, the selected ledger identifier is included in the dictionary version for the certification instant following the corresponding certification instant, that the corresponding version consistency proof is satisfied and that the selected ledger digest is included in the dictionary version for the selected certification instant according to the dictionary digests without knowledge of the dictionary versions, and
exposing, by the certification computing system, the verification information outside the private environment comprising the individual consistency proof.

10. The method according to any claim 4, wherein the method comprises:
building, by the certification computing system, the dictionary version for each of the certification instants comprising a search tree having a plurality of nodes comprising one or more leaf nodes of the nodes for the corresponding ledgers being identified by corresponding search keys based on the ledger identifiers of the corresponding ledgers, each of the leaf nodes containing the ledger identifier of the corresponding ledger, the ledger digest of the corresponding ledger for the corresponding certification instant and the possible corresponding version consistency proof, and one or more internal nodes of the nodes, each of the internal nodes having a plurality of corresponding fields for possible child nodes of the nodes descending therefrom each containing a hash value of the corresponding child node or a null value otherwise, and
calculating, by the certification computing system, the dictionary digest for each of the certification instants based on a root node of the nodes of the dictionary version for the corresponding certification instant and the dictionary digest for the possible certification instant preceding the corresponding certification instant along the sequence.

11. The method according to claim 10, wherein the method comprises:
a) calculating, by the certification computing system, an inclusion proof of the selected ledger identifier and the selected ledger digest,
the inclusion proof comprising a tree path of the dictionary version for the selected certification instant defined by the corresponding nodes along a search path of the selected ledger based on the selected ledger identifier for allowing the external computing systems to verify the selected ledger by:
a.1) calculating the dictionary digest for the selected certification instant from a first one of the nodes of the inclusion proof and the dictionary digest for the certification instant preceding the selected certification instant if different from the first certification instant, and verifying that the dictionary digest being calculated matches the dictionary digest for the selected certification instant being stored in the persistent storage,
a.2) verifying that the search key of a last one of the nodes of the inclusion proof is comprised in the search path of the selected ledger,
a.3) verifying that each of the nodes of the inclusion proof different from the last node is an internal node and has the field corresponding to the search path of the selected ledger containing the hash value of a next one of the nodes of the inclusion proof, and
a.4) verifying that the last node is a leaf node containing the selected ledger identifier and the selected ledger digest, and
b) exposing, by the certification computing system, the verification information outside the private environment comprising the inclusion proof.

12. The method according to claim 10, wherein the method comprises:
a) calculating, by the certification computing system, an individual consistency proof of the selected ledger identifier and the selected ledger digest
the individual consistency proof comprising corresponding membership proofs for the certification instants up to the selected certification instant along the sequence, each of the membership proofs comprising a tree path of the dictionary version for the corresponding certification instant defined by the corresponding nodes along a search path of the selected ledger based on the selected ledger identifier for allowing the external computing systems to verify the selected ledger comprising:
a.1) verifying each of the membership proofs by:
a.1.1) calculating the dictionary digest for the corresponding certification instant from a first one of the nodes of the membership proof and the dictionary digest for the certification instant preceding the corresponding certification instant if different from the first certification instant, and verifying that the dictionary digest being calculated matches the dictionary digest for the corresponding certification instant being stored in the persistent storage,
a.1.2) verifying that the search key of a last one of the nodes of the membership proof is comprised in the search path of the selected ledger,
a.1.3) verifying that each of the nodes of the membership proof different from the last node is an internal node and has the field corresponding to the search path of the selected ledger containing the hash value of a next one of the nodes of the membership proof,
a.1.4) verifying that if the last node is an internal node the last node has the field along the search path of the selected ledger containing the null value,
a.1.5) verifying that the selected ledger identifier is excluded from the dictionary version for the corresponding certification instant in response to the last node being a leaf node not containing the selected ledger identifier or an internal node having the field along the search path of the selected ledger containing the null value, or that the selected ledger identifier is included in the dictionary version for the corresponding certification instant in response to the last node being a leaf node containing the selected ledger identifier, and
a.1.6) verifying that the selected ledger identifier is excluded from the dictionary version for the possible certification instant preceding the corresponding certification instant if the selected ledger identifier is excluded from the dictionary version for the corresponding certification instant or verifying that the version consistency proof of the last node is satisfied if the selected ledger identifier is included in the dictionary versions for the corresponding certification instant and for the possible certification instant preceding the corresponding certification instant, and further comprising:
a.2) verifying that the selected ledger identifier and the selected ledger digest are included in the membership proof for the selected certification instant and
b) exposing, by the certification computing system, the verification information outside the private environment comprising the individual consistency proof.

13. The method according to claim, wherein the ledgers are a single ledger, the method comprising:
exposing, by the certification computing system, the verification information outside the private environment comprising the ledger digests and the version consistency proofs with at least the ledger digests being stored into the persistent storage.

14. (canceled)

15. A computer program product, the computer program product comprising one or more computer readable storage media having program instructions collectively stored on the readable storage media, the program instructions readable by a certification computing system being internal to a private environment to cause the certification computing system to perform a method for certifying data stored in one or more ledgers produced in the private environment, wherein the method comprises,
accessing corresponding ledger versions of each of the ledgers being generated by appending corresponding data thereto, the ledger versions being accessed for a sequence of certification instants,
calculating corresponding ledger digests based on all the data of the ledger versions of each ledger for the certification instants,
calculating corresponding versions consistency proofs of each ledger for one or more of the certification instants following a creation certification instant of the certification instants corresponding to a creation of the ledger, each of the version consistency proofs of the ledger being for verifying that the ledger version of the ledger for the corresponding certification instant is consistent with respect to the ledger version of the ledger for a preceding one of the certification instants immediately preceding the certification instant along the sequence, meaning that the ledger version for the certification instant contains the ledger version for the preceding certification instant without alteration and that the ledger version for the preceding certification instant has been obtained by extending the ledger digests without knowledge of the corresponding versions of the ledger, and
exposing verification information outside the private environment comprising storing at least part of the verification information for verifying integrity thereof into a persistent storage of persistent type being external to the private environment, the verification information being based on the ledger digesis and the version consistency proofs for allowing one or more external computing systems being external to the private environment to verify that each selected ledger of the ledgers to be verified has a single consistent history, meaning that each of the ledger versions of the selected ledger up to a selected one of the ledger versions of the selected ledger corresponding to a selected one of the certification instants along the sequence contains a preceding one of the ledger versions of the selected ledger version without alteration and that the ledger version has been obtained by extending the preceding ledger version, without knowledge of the corresponding ledger versions of the selected ledger.

16. (canceled)

17. A certification computing system for certifying data stored in one or more ledgers produced in a private environment, the certification computing system being internal to the private environment, wherein the certification computing system comprises:
a circuitry for accessing corresponding ledger versions of each of the ledgers being generated by appending corresponding data thereto, the ledger versions being accessed for a sequence of certification instants,
a circuitry for calculating corresponding ledger digests based on all the data of the ledger versions of each ledger for the certification instants,
a circuitry for calculating corresponding version consistency proofs of each ledger for one or more of the certification instants following of the ledger, each of the version consistency proofs of the ledger being for verifying that the ledger version of the ledger for the corresponding certification instant is consistent with respect to the ledger version of the ledger for a preceding one of the certification instants immediately preceding the certification instant contains the ledger version for the preceding certification instant without alteration and that the ledger version for the certification instant, according to the corresponding ledger digests without knowledge of the corresponding versions of the ledger, and
a circuitry for exposing verification information outside the private environment comprising storing at least part of the verification information for verifying integrity thereof into a persistent storage of persistent type being external to the private environment, the verification information being based on the ledger digests and the version consistency proofs for allowing one or more external computing systems being external to the private environment to verify that each selected ledger of the ledgers to be verified has a single consistent history, meaning that each of the ledger versions of the selected ledger up to a selected one of the ledger versions of the selected ledger corresponding to a selected one of the certification instants along the sequence contains a preceding one of the ledger versions of the selected ledger for the certification instant immediately preceding the certification instant of the ledger version without alteration and that the ledger version has been obtained by extending the preceding ledger version, without knowledge of the corresponding ledger versions of the selected ledger.

18. An information infrastructure for certifying data comprising the certification computing system according to claim 17 and one or more external computing systems each comprising a circuitry for verifying that each selected ledger has the single consistent history according to the verification information without knowledge of the corresponding ledger versions of the selected ledger.

19. The information technology infrastructure according to claim 20, further comprising one or more monitoring computing systems each comprising:
a circuitry for determining corresponding global consistency indicators for the certification instants, the global consistency indicator for each of the certification instants being determined by verifying that all the ledger identifiers that are included in each of the dictionary versions, for a corresponding one of the certification instants preceding the selected certification instant along the sequence, are included in the dictionary version for the certification instant following the certification instant and that the corresponding version consistency proofs are satisfied, and
a circuitry for returning an indication of the global consistency indicators for the certification instants up to the selected certification instant along the sequence in response to a corresponding query from each of the external computing systems.

20. The information technology infrastructure according to claim 18, wherein the ledgers are a plurality of ledgers identified by corresponding ledger identifiers, the certification computing system further comprising:
a circuitry for building corresponding dictionary versions of a dictionary for the certification instants, each of the dictionary versions comprising corresponding records for one or more of the ledgers having been created before the corresponding certification instant each associated with the ledger identifier of the corresponding ledger and comprising the ledger digest of the corresponding ledger and the possible version consistency proof of the corresponding ledger for the corresponding certification instant,
a circuitry for calculating corresponding dictionary digests based on the dictionary versions for the certification instants, and
a circuitry for exposing the verification information outside the private environment comprising storing the dictionary digests into the persistent storage and publishing the dictionary versions into a public storage, and
wherein each of the external computing systems comprises a circuitry for verifying that a selected one of the ledger identifiers of the selected ledger is excluded from the dictionary versions for any of the certification instants preceding the creation instant thereof along the sequence, that the selected ledger identifier is included in the dictionary selected ledger up to the selected certification instant along the sequence with the dictionary version for the selected certification instant containing a selected one of the ledger digests of the selected ledger version, and that the corresponding version consistency proofs are satisfied.
